(19) United States
(12) Patent Application Publication
(10) Pub. No.: US 2019/0144654 A1
(43) Pub. Date: May 16, 2019

(54) Curative System for Butyl Based Compositions

(71) Applicant: ExxonMobil Chemical Patents Inc., Baytown, TX (US)

(72) Inventors: Sujith Nair, League City, TX (US); Sunny Jacob, Seabrook, TX (US); Yuan-Ju Chen, Houston, TX (US)

(21) Appl. No.: 16/145,920

(22) Filed: Sep. 28, 2018

Related U.S. Application Data
(60) Provisional application No. 62/586,286, filed on Nov. 15, 2017.

(51) Int. Cl. C08L 23/22; C08F 10/10; B60C 1/00

(52) U.S. Cl. CPC C08L 23/22; C08F 10/10; B60C 1/0008; C08L 2205/06; C08L 2205/03; C08L 2205/035; C08L 2205/08; B60C 1/0041

(57) ABSTRACT

Curative systems for butyl based compositions are provided herein. The present curative systems provide consistent curing speeds for butyl based compositions, low moduli at low strain, higher elongation and higher percent retention in elongation at heat aging conditions. The curative systems have about 0.5 phr to about 3 phr metal oxide, about 0.3 phr to about 3 phr fatty acid, at least to about 2 phr sulfur, and at least about 2 phr of cure accelerator.

### CROSS-REFERENCE TO RELATED APPLICATIONS

This application claims priority to U.S. Ser. No. 62/586,286, filed Nov. 15, 2017, herein incorporated by reference.

### FIELD OF THE INVENTION

The present disclosure relates to compositions, preferably butyl based compositions, and more particularly relates to curative systems for the compositions to increase cure rate and improve retention in elongation of the compositions.

### BACKGROUND OF THE INVENTION

Isobutylene co-para-methyl styrene elastomer compositions have improved permeability characteristics which are useful in a variety of applications such as tire inner liners. The presence of the para-methyl styrene ring helps in efficient chain packing which renders lower permeability. However, the co-para-methyl styrene butyl based compositions have drawbacks when compared to other butyl based compositions such as isobutylene-isoprene butyl based compositions. Such drawbacks can include a slower cure, an increase in moduli at low strains, which could cause flex fatigue cracking, and poor retention in elongation at heat aging conditions.

A need exists, therefore, for a formulation of compositions whereby butyl based compositions have consistent curing speeds, low moduli at low strains, higher elongations and a higher percent retention in elongation at heat aging conditions, each a desirable application based characteristic, especially for tire inner liners.

### SUMMARY OF THE INVENTION

Disclosed herein is a curative system comprising: (a) about 0.5 to about 3 phr metal oxide; (b) about 0.3 to about 3 phr fatty acid; (c) less than or equal to about 2 phr sulfur; and (d) less than or equal to about 2 phr cure accelerator.

Also disclosed is a composition comprising (a) an isobutylene based polymer or an isobutylene copolymer; and (b) a curative system, comprising the reaction product of about 0.5 to about 3 phr metal oxide, about 0.5 to about 3 phr fatty acid, less than or equal to about 2 phr sulfur; and less than or equal to about 2 phr cure accelerator.

### DESCRIPTION OF THE PREFERRED EMBODIMENTS

Various specific embodiments, versions and examples are described herein, including exemplary embodiments and definitions that are adopted for purposes of understanding the claimed invention. While the following detailed description gives specific preferred embodiments, those skilled in the art will appreciate that these embodiments are exemplary only, and that the invention can be practiced in other ways. For purposes of determining infringement, the scope of the invention will refer to any one or more of the appended claims, including their equivalents, and elements or limitations that are equivalent to those that are recited. Any reference to the “invention” may refer to one or more, but not necessarily all, of the inventions defined by the claims.

As used herein, the term “elastomer” may be used interchangeably with the term “rubber” and refers to any composition comprising at least one elastomer.

The term “rubber” refers to any polymer or composition of polymers consistent with the ASTM D1566 definition: “a material that is capable of recovering from large deformations, and can be, or already is, modified to a state in which it is essentially insoluble (but can swell) in boiling solvent.”

The term “vulcanized rubber” refers to a crosslinked elastic material compounded from an elastomer, susceptible to large deformations by a small force capable of rapid, forceful recovery to approximately its original dimensions and shape upon removal of the deforming force as defined by ASTM D1566.

The term “hydrocarbon” refers to molecules or segments of molecules containing primarily hydrogen and carbon atoms. In some molecules, hydrocarbon also includes halogenated versions of hydrocarbons and hydrocarbons containing heteroatoms.

The term “inert hydrocarbons” refers to piperylene, aromatic, styrenic, amylene, cyclic pentadiene components, and the like, as saturated hydrocarbons or hydrocarbons which are otherwise essentially non-polymerizable in carbocationic polymerization systems, e.g., the inert compounds have a reactivity ratio relative to cyclopentadiene less than 0.01.

The term “phr” refers to parts per hundred rubber and is a measure of the component of a composition relative to 100 parts by weight of the elastomer (rubber component) as measured relative to total elastomer. The total phr (or parts for all rubber components, whether one, two, three, or more different rubber components) is always defined as 100 phr. All other non-rubber components are a ratio of the 100 parts of rubber and are expressed in phr.

The term “polymer” refers to homopolymers, copolymers, interpolymers, terpolymers, etc. Likewise, a copolymer refers to a polymer comprising at least two monomers, optionally with other monomers.

The term “copolymer” refers to random polymers of C₄ to C₇ isoolefins derived units and alkylstyrene. For example, a copolymer can contain at least 85% by weight of the isoolefin, about 8 to about 12% by weight alkylstyrene, and about 1.1 to about 1.5 wt % of a halogen. For example, a copolymer can be a random elastomeric copolymer of a C₄ to C₇ alpha-olefin and a methylstyrene containing at about 8 to about 12% by weight methylstyrene, and 1.1 to 1.5 wt % bromine or chlorine. Alternatively, random copolymers of isobutylene and para-methylstyrene (“PMS”) can contain from about 4 to about 10 mol % para-methylstyrene wherein up to 25 mol % of the methyl substituent groups present on the benzyl ring contain a bromine or chlorine atom, such as a bromine atom (para-(bromomethylstyrene)), as well as acid or ester functionalized versions thereof. Furthermore, copolymers can be substantially free of ring halogen or halogen in the polymer backbone chain. In one embodiment, the random polymer is a copolymer of C4 to C7 isoolefin derived units (or isomonoolefin), para-methylstyrene derived units and para-(halomethylstyrene) derived units, wherein the para-(halomethylstyrene) units are present in the polymer from about 10 to about 22 mol % based on the total number of para-methylstyrene, and wherein the para-methylstyrene derived units are present from 8 to 12 wt % based on the total weight of the polymer or from 9 to 10.5 wt %. Also, for example, para-(halomethylstyrene) can be para-(bromomethylstyrene).

The term “alkyl” refers to a paraffinic hydrocarbon group which may be derived from an alkane by dropping one or more hydrogens from the formula, such as, for example, a methyl group (CH₃), or an ethyl group (CH₃CH₂).

The term “aryl” refers to a hydrocarbon group that forms a ring structure characteristic of aromatic compounds such as, for example, benzene, naphthalene, phenanthrene, anthracene, etc., and typically possess alternate double bonding (“unsaturation”) within its structure. An aryl group is thus a group derived from an aromatic compound by dropping one or more hydrogens from the formula such as, for example, phenyl, or C₆H₅.

The term “isoolefin” refers to a C₄ to C₇ compound and includes, but is not limited to, isobutylene, isobutene 2-methyl-1-butene, 3-methyl-1-butene, 2-methyl-2-butene, and 4-methyl-1-pentene. The multiolefin is a C₄ to C₁₄ conjugated diene such as isoprene, butadiene, 2,3-dimethyl-1,3-butadiene, myrcene, 6,6-dimethyl-fulvene, cyclopentadiene, hexadiene and piperylene. An exemplary polymer can be obtained by reacting 92 to 99.5 wt % of isobutylene with 0.5 to 8 wt % isoprene, or reacting 95 to 99.5 wt % isobutylene with from 0.5 to 5.0 wt % isoprene.

The term “substituted” refers to at least one hydrogen group being replaced by at least one substituent selected from, for example, halogen (chlorine, bromine, fluorine, or iodine), amino, nitro, sulfoxy (sulfonate or alkyl sulfonate), thiol, alkylthiol, and hydroxy; alkyl, straight or branched chain having 1 to 20 carbon atoms which includes methyl, ethyl, propyl, isopropyl, normal butyl, isobutyl, secondary butyl, tertiary butyl, and the like; alkoxy, straight or branched chain alkoxy having 1 to 20 carbon atoms, and includes, for example, methoxy, ethoxy, propoxy, isopropoxy, butoxy, isobutoxy, secondary butoxy, tertiary butoxy, pentyloxy, isopentyloxy, hexyloxy, heptyloxy, octyloxy, nonyloxy, and decyloxy; haloalkyl, which means straight or branched chain alkyl having 1 to 20 carbon atoms which is substituted by at least one halogen, and includes, for example, chloromethyl, bromomethyl, fluoromethyl, iodomethyl, 2-chloroethyl, 2-bromoethyl, 2-fluoroethyl, 3-chloropropyl, 3-bromopropyl, 3-fluoropropyl, 4-chlorobutyl, 4-fluorobutyl, dichloromethyl, dibromomethyl, difluoromethyl, diiodomethyl, 2,2-dichloroethyl, 2,2-dibromoethyl, 2,2-difluoroethyl, 3,3-dichloropropyl, 3,3-difluoropropyl, 4,4-dichlorobutyl, 4,4-dibromobutyl, 4,4-difluorobutyl, trichloromethyl, trifluoromethyl, 2,2,2-trifluoroethyl, 2,3,3-trifluoropropyl, 1,1,2,2-tetrafluoroethyl, and 2,2,3,3-tetrafluoropropyl. Thus, for example, a “substituted styrenic unit” includes p-methylstyrene, and p-ethylstyrene, and the like.

As used herein, the term “butyl based composition” is sometimes referred to herein as “butyl based elastomer composition,” “butyl based polymer composition,” “isobutylene based composition,” “isobutylene based elastomer composition” and/or “isobutylene based polymer composition.”

As used herein, the term “isobutylene based elastomer” refers to elastomers or polymers comprising a plurality of repeat units from isobutylene. The term “isobutylene based elastomer” or “isobutylene based polymer” refers to elastomers or polymers comprising at least 70 mole percent repeat units from isobutylene.

The term “rubber” includes, but is not limited to, at least one or more of brominated butyl rubber, chlorinated butyl rubber, star-branched polyisobutylene rubber, star-branched brominated butyl (polyisobutylene/isoprene copolymer) rubber; halogenated poly(isobutylene-co-p-methylstyrene), such as, for example, terpolymers of isobutylene derived units, p-methylstyrene derived units, and p-bromomethylstyrene derived units (BrIBMS), and the like halomethylated aromatic interpolymers as in U.S. Pat. Nos. 5,162,445, 4,074,035, and 4,395,506; halogenated isoprene and halogenated isobutylene copolymers, polychloroprene, and the like, and mixtures of any of the above. Halogenated rubbers are also described in U.S. Pat. Nos. 4,703,091 and 4,632,963.

As used herein, “halogenated butyl rubber” refers to both butyl rubber and so-called “star-branched” butyl rubber, described below. The halogenated rubber can be a halogenated copolymer of a C₄ (as noted sometimes as “C4”) to C₇ (also noted sometimes as “C7”) isoolefin and a multiolefin. The halogenated rubber component can be a blend of a polydiene or block copolymer, and a copolymer of a C₄ to C₇ isoolefin and a conjugated, or a “star-branched” butyl polymer. The halogenated butyl polymer can be described as a halogenated elastomer comprising C₄ to C₇ isoolefin derived units, multi-olefin derived units, and halogenated multiolefin derived units, and includes both “halogenated butyl rubber” and so called “halogenated star-branched” butyl rubber.

As described herein, rubber can be a halogenated rubber or halogenated butyl rubber such as brominated butyl rubber or chlorinated butyl rubber. General properties and processing of halogenated butyl rubbers is described in THE VANDERBILT RUBBER HANDBOOK 105-122 (R. F. Ohm ed., R.T. Vanderbilt Co., Inc. 1990), and in RUBBER TECHNOLOGY 311-321 (1995). Butyl rubbers, halogenated butyl rubbers, and star-branched butyl rubbers are described by E. Kresge and H. C. Wang in 8 KIRK-OTHMER ENCYCLOPEDIA OF CHEMICAL TECHNOLOGY 934-955 (John Wiley & Sons, Inc. 4th ed. 1993).

Halogenated butyl rubber can be produced from the halogenation of butyl rubber. Preferably, the olefin polymerization feeds employed in producing halogenated butyl rubber include those olefinic compounds conventionally used in the preparation of butyl-type rubber polymers. The butyl polymers are prepared by reacting a co-monomer mixture, the mixture having at least one (1) C₄ to C₇ isoolefin monomer component such as isobutylene with (2) a multi-olefin, or conjugated diene, monomer component. The isoolefin is in a range from 70 to 99.5 wt % by weight of the total comonomer mixture, or 85 to 99.5 wt %. The conjugated diene component is present in the comonomer mixture from 30 to 0.5 wt % or from 15 to 0.5 wt %. From 8 to 0.5 wt % of the co-monomer mixture is conjugated diene.

Halogenated butyl rubber is produced by the halogenation of a butyl rubber product. Halogenation can be carried out by any means, and the invention is not herein limited by the halogenation process. Methods of halogenating polymers such as butyl polymers are disclosed in U.S. Pat. Nos. 2,631,984, 3,099,644, 4,554,326, 4,681,921, 4,650,831, 4,384,072, 4,513,116 and 5,681,901. The halogen can be in the so called II and III structures as discussed in, for example, RUBBER TECHNOLOGY at 298-299 (1995). The butyl rubber can be halogenated in hexane diluent at from 40 to 60° C. using bromine (Br₂) or chlorine (Cl₂) as the halogenation agent. The halogenated butyl rubber has a Mooney viscosity of from 20 to 70 (ML 1+8 at 125° C.), or from 25 to 55. The halogen content is from 0.1 to 10 wt % based in on the weight of the halogenated butyl rubber or from 0.5 to 5 wt %. The halogen wt % of the halogenated butyl rubber is from 1 to 2.2 wt %.

As used herein, EXXPRO® refers to a brominated isobutylene para methyl styrene (BIMSM) rubber or isobutylene-co-para-methyl-styrene based elastomer, produced by catalytic polymerization of isobutylene and isoprene and manufactured by ExxonMobil useful in a variety of consumer applications including tires and medical tube stoppers.

EXXON™ Bromobutyl or Bromobutyl refers to brominated isobutylene-isoprene rubber or BIIR manufactured by ExxonMobil Chemical, a family of butyl rubbers used in a variety of consumer applications including tires and medical tube stoppers.

Bromobutyl 2222, also known as BIIR 2222, refers to a brominated copolymer of isobutylene and isoprene having a specific gravity of 0.93; a Mooney viscosity target of 32, a minimum of 28, and a maximum of 36; a bromine composition target of 1.03%, a minimum of 0.93%, and a maximum of 1.13%; and a calcium composition target of 0.15%, a minimum of 0.12%, and a maximum of 0.18%.

ESCOREZ™ refers to petroleum hydrocarbon tackifiers or tackifier resins. There are two major families of this product line, the first has major components of C₅ to C₆ olefins and diolefins (1000 and 2000 series) that are catalytically polymerized. The second family has major components that are polycyclodienes (C₁₀ to C₁₂) Cyclodiene dimers plus dicyclopentadiene with or without C₈ to C₁₀ vinyl aromatics) (5000 series) that are thermally polymerized. These resins can be used to enhance the tack properties of a variety of adhesive polymers. Applications for these resins include hot melt adhesives and pressure sensitive adhesives.

ESCOREZ™ 1102 refers to an aliphatic homogenizing resin having a softening point of 100° C., a melt viscosity of 1650 cP, a molecular weight-number average (Mn) of 1300 g/mol and a molecular weight−weight average (Mw) of 2900 g/mol useful to increase tack and adhesive properties and modify mechanical and optical properties of polymer blends and thermally polymerized.

STRUKTOL™ 40 MS refers to a homogenizing resin by Struktol Company of America and a mixture of aromatic and aliphatic hydrocarbon resins designed to improve the homogeneity of elastomers and effective with elastomer blends which tend to crumble at the beginning of the mixing cycle. STRUKTOL™ 40 MS increases the greentack of some compounds, boosts the efficiency of other tackifying agents and has good solubility in aromatic and chlorinated hydrocarbon oils.

MAGLITE™ K refers to a magnesium oxide compound manufactured by Hallstar designed to produce a lower activity product for applications where longer reaction time is required. MAGLITE™ K can be used in a wide variety of polymer applications including fluoroelastomers, butyl, chlorobutyl, chlorinated rubber, chlorosulfonated polyethylene, and nitrile. The specifications of MAGLITE™ K include a composition of 94.5% Magnesium Oxide, 1.0% calcium oxide, and 0.03% chloride; ignition loss of 4.0%; mean particle size of 2.0 microns; bulk density of 417 kg/m³; and a BET surface area of 40 m²/g.

KADOX™ 911 refers to a zinc oxide manufactured by Horsehead Corporation and is a French process, high purity, very fine particle size zinc oxide. KADOX™ 911 is designed to provide a zinc oxide with high surface area and reactivity with minimum setting and opacity. In rubber, KADOX™ 911 is designed to provide high activating power and reinforcement with an accelerating effect. The specifications for KADOX™ 911 include a composition of zinc oxide 99.9%, cadmium oxide 0.005%, iron (III) oxide 0.001%, lead oxide 0.001%, and water soluble salts 0.02%; a mean surface particle diameter of 0.12 microns; a specific surface of 9.0 m²/g; a specific gravity of 5.6; and an apparent density of 561 kg/m³.

ALTAX™ MBTS refers to mercaptobenzothiazole disulfide, is also referred to as benzothiazyl disulfide, manufactured by Vanderbilt Chemicals, LLC and useful in natural and synthetic rubbers as a primary accelerator and scorch-modifying secondary accelerator in NR and SBR copolymers, in neoprene G types as a retarder or plasticizer, and in W types as a cure modifier. ALTAX™ MBTS is moderately soluble in toluene and chloroform, insoluble in gasoline and water and is 94% benzothiazole disulfide and 5% white mineral oil. ALTAX™ MBTS includes an ash content of 0.7% maximum, a heat loss of 1.0% maximum, a melting range of 164° C. to 179° C., and a density at 20° C. of 1.54 Mg/m³.

Rubbermakers Sulfur OT refers to an oil treated grade of sulfur used to vulcanize rubber compounds having properties which include a sulfur purity of 99.0%, a heat loss of 0.15%, ash content of 0.10%, an acidity as H₂SO₄ of 0.01%, an oil treatment of 0.5%, and a specific gravity of 2.07.

CONTINEX™ Carbon Black N660 refers to a furnace grade carbon black compound manufactured by Continental Carbon Company and is both tire grade and mechanical rubber grade. CONTINEX™ Carbon Black N660 has the following specifications: iodine adsorption of 36 g/kg; oil absorption 90 10-5 m³/kg; oil absorption compressed of 74 10-5 m³/kg/NSA multipoint of 35 m²/g; STSA of 34 m²/g; pour density of 440 kg/m³ or 441 kg/ft³ and a delta stress at 300% elongation of 2.3 MPa or −330 psi and is useful in carcass and innerliner functions for tires, medium reinforcing for innertubes, cable insulation, and body mounts for mechanical rubber.

Calsol-810 refers to a naphthenic oil manufactured by Calumet Specialty Products and is refined form a blend of naphthenic crudes using a multistage hydrogenation process, compatible with synthetic elastomers and their additives and designed to increase viscosity-gravity constants and aromatics levels, and lower aniline points. It exhibits high VGC levels and low aniline points. This compound can be used in a variety of compounds, including but not limited to adhesives, defoaming agents for paper and paperboard, defoaming agents used in coatings, textiles and textile fibers, resin bonded filers, animal glue defoamer, surface lubricants for the manufacture of metallic articles such as rolling foils and sheet stock, and rubber articles intended for repeated use. The specifications of Calsol-810 include a viscosity at 40° C. minimum of 18.70, maximum of 21.70; API gravity minimum of 23.5, maximum of 26.0; flash point minimum of 160° C.; Pour point maximum of −34° C.; aniline point minimum of 68.3° C. and maximum of 76.7° C.

HYSTRENE™ 5016 NF, herein referred to as Stearic Acid 5016NF, refers to a high purity mixture of saturated food grade fatty acids with an approximate 50% palmitic acid content. It has a low iodine value and is used for applications requiring excellent heat and color stability. The specifications of HYSTRENE™ 5016 NF include an iodine value maximum of 0.5, a transmittance color at 440 nm of 92 to 100, a transmittance color at 550 nm of 98 to 100, C₁₄ percentage maximum of 3.0%, C₁₆ percentage range of 47% to 55%, C₁₈ percentage range of 40% to 50%, C₁₆ and C₁₈ percentage minimum of 90%, and a water percentage maximum of 0.20%.

Butyl based compositions such as isobutylene co-para-methyl styrene elastomer compositions have improved permeability characteristics which is useful in a variety of applications such as tire inner liners. The presence of the para-methyl styrene ring helps in efficient chain packing which renders lower permeability. However, certain butyl based compositions have drawbacks such as slow cure, increase in moduli at low strains, which could cause flex fatigue cracking and poor retention in elongation at heat ageing conditions. The present curative systems serve to address these limitations through a formulation (or range of formulations) whereby the butyl based compositions have similar curing speeds, low moduli at low strains, much higher elongations and high percent retention in elongation at heat ageing conditions, which are desirable application based characteristics, especially for tire inner liners.

The inventors have discovered a unique combination of cure additives suitable for use in the invention, including metal oxides, metal fatty acid complex or fatty acid, sulfur, and a cure accelerator. Metal oxides suitable for use in the cure package of the invention include ZnO, CaO, MgO, Al₂O₃, CrO₃, FeO, Fe₂O₃, and NiO. Suitable metal fatty acid complex useful in the invention include zinc stearate and calcium stearate. A suitable fatty acid for use in the invention is stearic acid. Suitable cure accelerators for use in the invention include diphenyl guanidine, tetramethylthiram disulfide, 4-4′-diothiodimorpholine, tetrabutylthiram disulfide, benzothiazyl disulfide, hexamethylene-1,6-bisthiosulfate disodium salt dehydrate, 2-morpholinothio benzothiazole, N-tertiary-butyl-2-benzothiazole sulfonamide, N-oxydiethylene thiocarbanyl-N-oxdyiethylene sulfonamide, zinc 2-ethyl hexanoate, and mercaptobenzothiazole disulfide.

The present disclosure provides butyl based compositions formulated to improve curing speeds and elongation while providing a low modulus at low strain and high percent of retention. Generally, the present butyl based compositions comprise a primary polymer and further include a secondary polymer, a resin, and a novel curative system described herein. The present butyl based compositions can also comprise a process oil, a filler, and/or a plasticizer.

The primary polymer (also referred to as “the polymer”) includes at least one isobutylene based polymer, homo-polymer, copolymer, or blend of the same. More specifically, the primary polymer can be an isobutylene copolymer such as isobutylene polymerized with co-monomers (other than isoprene) such as isobutylene co-para-methyl styrene copolymer (also referred to as isobutylene co-para-methyl styrene elastomer) and halogenated versions of the same. Further examples of primary polymers include isobutylene-isoprene elastomers such as butyl (“IIR”), halogenated elastomers such as bromobutyl (“BIIR”), chlorobutyl (“CIIR”), star branched bromobutyl (“SBB”), and star branched chlorobutyl (“SBC”) and brominated isobutylene para-methyl styrene (“BIMSM”). Isobutylene co-para-methyl styrene elastomer and brominated isobutylene para-methyl styrene (“BIMSM”) rubber are currently sold under the trade name of EXXPRO.

Table 1 provides exemplary primary polymers and associated properties.

TABLE 1
Exemplary Isobutylene Based Polymers

| | | | | Para- | | | |
|---|---|---|---|---|---|---|---|
| | | Mooney Viscosity | Isoprene | Methylstyrene | | Halogen | Halogen |
| Elastomer | Grade | (ML1 + 8 @ 125° C.) | (mol. %) | (wt. %) | Halogen | (wt. %) | (mol. %) |
| BUTYL | 065 | 32 | 1.05 | — | — | — | — |
| (low viscosity) | 365 | 33 | 2.30 | — | — | — | — |
| BUTYL | 068 | 51 | 1.15 | — | — | — | — |
| (medium | 268 | 51 | 1.70 | — | — | — | — |
| viscosity) | | | | | | | |
| CHLORO- | 1066 | 38 | 1.95 | — | Cl | 1.26 | — |
| BUTYL | | | | | | | |
| BROMO- | 2222 | 32 | 1.70 | — | Br | 2.00 | — |
| BUTYL | | | | | | | |
| BROMO- | 2235 | 39 | 1.70 | — | Br | 2.00 | — |
| BUTYL | | | | | | | |
| BROMO- | 2255 | 46 | 1.70 | — | Br | 2.00 | — |
| BUTYL | | | | | | | |
| BROMO- | 2211 | 32 | 1.70 | — | Br | 2.10 | — |
| BUTYL | | | | | | | |
| BROMO- | 2244 | 46 | 1.70 | — | Br | 2.10 | — |
| BUTYL | | | | | | | |
| BROMO- | 7211 | 32 | 1.70 | — | Br | 2.00 | — |
| BUTYL | | | | | | | |
| BROMO- | 7244 | 46 | 1.7 | — | Br | 2.00 | — |
| BUTYL | | | | | | | |
| SBB | 6222 | 32 | 1.70 | — | Br | 2.40 | — |
| SBC | 5066 | 32 | — | — | Cl | 1.26 | — |
| EXXPRO ® | 3035 | 45 | — | 5.00 | Br | — | 0.47 |
| EXXPRO ® | 3433 | 35 | — | 5.00 | Br | — | 0.75 |
| EXXPRO ® | 3745 | 45 | — | 7.50 | Br | — | 1.20 |
| EXXPRO ® | 03-1 | 35 | — | 10.00 | Br | — | 0.80 |

As primary polymer or secondary polymer, a halogenated butyl or star-branched butyl rubber can be halogenated such that the halogenation is primarily allylic in nature. This can be achieved as a free radical bromination or free radical chlorination, or by such methods as secondary treatment of electrophilically halogenated rubbers, such as by heating the rubber, to form the allylic halogenated butyl and star-branched butyl rubber. Exemplary methods of forming the allylic halogenated polymer are disclosed by Gardner et al. in U.S. Pat. Nos. 4,632,963, 4,649,178, and 4,703,091. Thus, the halogenated butyl rubber can be halogenated in multi-olefin units which are primary allylic halogenated units, and wherein the primary allylic configuration is present to at least 20 mole % (relative to the total amount of halogenated multi-olefin).

Star-branched halogenated butyl rubber (“SBHR”) is a composition of a butyl rubber, either halogenated or not, and a polydiene or block copolymer, either halogenated or not. This halogenation process is described in detail in U.S. Pat. Nos. 4,074,035, 5,071,913, 5,286,804, 5,182,333 and 6,228,978. The secondary polymer is not limited by the method of forming the SBHR. The polydienes/block copolymer, or branching agents (hereinafter “polydienes”), are typically cationically reactive and are present during the polymerization of the butyl or halogenated butyl rubber, or can be blended with the butyl or halogenated butyl rubber to form the SBHR. The branching agent or polydiene can be any suitable branching agent, and the invention is not limited to the type of polydiene used to make the SBHR.

The SBHR is typically a composition of the butyl or halogenated butyl rubber as described above and a copolymer of a polydiene and a partially hydrogenated polydiene selected from the group including styrene, polybutadiene, polyisoprene, polypiperylene, natural rubber, styrene-butadiene rubber, ethylene-propylene diene rubber, styrene-butadiene-styrene and styrene-isoprene-styrene block copolymers. These polydienes are present, based on the monomer wt %, greater than 0.3 wt %, or from 0.3 to 3 wt % or from 0.4 to 2.7 wt %.

A commercial SBHR is Bromobutyl 6222 (ExxonMobil Chemical Company), having a Mooney viscosity (ML 1+8 at 125° C.) of from 27 to 37, and a bromine content of from 2.2 to 2.6 wt % relative to the SBHR. Further, cure characteristics of Bromobutyl 6222 are as follows: MH is from 24 to 38 dNm, ML is from 6 to 16 dNm.

An exemplary halogenated butyl rubber is Bromobutyl 2222 (ExxonMobil Chemical Company). Its Mooney viscosity is from 27 to 37 (ML 1+8 at 125° C.), and the bromine content is from 1.8 to 2.2 wt % relative to the Bromobutyl 2222. Further, cure characteristics of Bromobutyl 2222 are as follows: MH is from 28 to 40 dNm, ML is from 7 to 18 dNm. Another commercial available halogenated butyl rubber used as the secondary polymer is Bromobutyl 2255 (ExxonMobil Chemical Company). Its Mooney viscosity is from 41 to 51 (ML 1+8 at 125° C.), and the bromine content is from 1.8 to 2.2 wt %. Further, cure characteristics of Bromobutyl 2255 are as follows: MH is from 34 to 48 dNm, ML is from 11 to 21 dNm.

Primary polymers can be solution mixed, melt mixed, solid state mixed or reactor mixed blends of two or more of the above elastomers. The isobutylene based composition can comprise of primary polymers from 30 to 100 phr, or from 50 to 100 phr, or from 70 to 100 phr.

As noted above, the butyl based composition can further include secondary polymers. Secondary polymers include, but are not limited to, natural rubber (“NR”), cis-polyisoprene (“IR”), solution, emulsion styrene butadiene rubber (“s-SBR” and “e-SBR”), and ethylene propylene diene rubber (“EPDM”). The secondary polymer can include derivatives and functionalized variations of polymer, and solution mixed, melt mixed, solid state mixed or reactor mixed blends of two or more of the above mentioned primary and secondary elastomers and their derivatives. The butyl based composition comprises a secondary polymer (or a combination of their blends) from 0 to 70 phr, from 0 to 50 phr, and from 0 to 30 phr. The total of the primary and secondary polymer is 100 phr.

The butyl based composition can also include at least one filler or multiple fillers. Fillers are used for imparting sufficient green strength to the compound to enable smooth processing, and for achieving the required balance of mechanical properties in the cured compounds (high strength, modulus and toughness). Addition of a filler or combination of fillers can assist in significantly reducing the butyl based composition permeability. However, increased amounts of filler can result in poor fatigue resistance and crack properties. Specific fillers include carbon black, silica, silicates, calcium carbonate, clays (low and high aspect ratio), mica, aluminum oxide, starch, or mixtures thereof. Furthermore, the fillers may be intercalated, exfoliated, layered, functionalized or pre-treated with certain chemicals in some cases. In some cases, the filler can be pre-mixed with the primary or secondary polymer, or their combination, and introduced as a masterbatch into the composition. The butyl based composition comprises fillers (or a combination of fillers) from 0 to 100 phr, from 20 to 90 phr, and from 30 to 80 phr.

The butyl based composition also includes process oil, or blends of two or more process oils. The presence of oil aids in processing the polymer during mixing. The addition of oil increases the mixing time by reducing the compound temperature. Typically, the molecular weight of oils is low. Therefore, the oil can also act as a plasticizer by increasing the free volume and decreasing the overall compound Tg. However, the addition of oil has also been shown to increase the permeability coefficient, which is undesirable for butyl based composition for inner liner applications.

For present butyl based compositions, useful process oils include paraffinic oils, naphthalenic oils, treated distillate aromatic extracts (“TDAE”), methyl-ethyl-ketone oils (“MEK”), poly-alpha-olefins (“PAO”), hydrocarbon fluid additives (“HFA”), polybutene oils (“PB”), or mixtures thereof. The amount of process oil (or a combination of fillers) in the present butyl based compositions comprise from about 0 to about 20 phr, from 0 to about 14 phr, and from 0 to about 8 phr.

The present butyl based composition can further comprise a plasticizer including (but is not limited to) sebacates, adipates, phthalates, tallates, or benzoates, to impart improved cold temperature properties (and improved freeze resistance) to rubber compounds by decreasing the compound Tg. The plasticizer increases chain spacing, thereby increasing the free volume of the polymer, thereby decreasing the compound Tg. However, addition of a plasticizer can increase the permeability coefficient, which is undesirable for compositions used in inner liner applications.

Homogenizing resins of the present butyl based compositions can be produced by various different processes and are not limited to any one manufacturing methodology. However, in one process, present homogenizing resins are made by combining feed streams in a polymerization reactor with a Friedel-Crafts or Lewis Acid catalyst at a temperature between 0° C. and 200° C. (generally around 20° C. to 30° C.). The feed streams comprise raffinates of the EXXONMOBIL ESCOREZ™ E5000 process. Friedel-Crafts polymerization is generally accomplished by use of known catalysts in a polymerization solvent, and the solvent and catalyst may be removed by washing and distillation. The homogenizing resin described herein is not limited to the commercial source of any of halogenated rubber.

This polymerization process may be batch wise or continuous mode. Continuous polymerization may be accomplished in a single stage or in multiple stages. Nonaromatic components can include recycle feed stream of the chemical plant. The component of the feed streams are generally a synthetic mixture of cis-1, 3-pentadiene, trans-1, 3-pentadiene, and mixed 1, 3-pentadiene. In general, feed components do not include branched C₅ diolefins such as isoprene. The feed component may be supplied in one embodiment as a mixed distillate cut or synthetic mixture comprising up to 20 wt % cyclopentadiene or dimer of cyclopentadiene up to 30 wt % of other components, such as, for example, 10 to 20 wt % cyclopentene, 10 to 20 wt % inert hydrocarbons, and optionally relatively minor amounts of one or more other olefins and diolefins such as methyl-cyclopentadiene or dimer or trimers of methyl-cyclopentadiene, and the like.

Petroleum fractions containing aliphatic C₅ to C₆ linear, branched, alicyclic mono-olefins, diolefins, and alicyclic C₁₀ diolefins can be polymerized. The aliphatic olefins can comprise one or more natural or synthetic terpenes, preferably one or more of alpha-pinenne, dipentene, limonene or isoprene dimers. C₈-C₁₂ aromatic/olefinic streams containing styrene, vinyl toluene, indene, or methyl-indene can also be polymerized as such or in mixture with the aliphatic streams. After the polymerization is complete the reaction mixture is quenched with isopropanol and water mixture. The aqueous layer is then separated from the reaction mixture using a separating funnel. The reaction mixture can contain several non-polymerizable molecules/paraffins. These are separated from the polymerized homogenizing resin by steam stripping.

### Effects of the Present Curative Systems on Butyl Based Compositions

The butyl based compositions described herein can be prepared by conventional methods used in the tire and rubber industries. For example, isobutylene based elastomers are often prepared in two stages (although, in some cases, it could be done in one stage). In the first stage, also called the non-productive stage, the elastomers are mixed with the filler and processing aids (excluding the curative system). In the second stage, also called the productive stage (or final stage), the non-productive batch is mixed with the curative system.

Typically, the final temperatures and total mixing times achieved in the non-productive stage is much greater than the productive stage. Typically, the final temperatures in the non-productive and productive mix ranges from 120° C. to 170° C. and 90° C. to 110° C. respectively. The mixing times depend on the mixer, the rotor configuration, rotor speed, the mixer cooling mechanism, the amount and type of filler used, the composition of the elastomer (heat conductivity of the elastomer), the oil addition time, and several other factors. The compositions described were prepared in a 1570 cc BANBURRY™ mixer (Black BR) or 5310 cc BANBURRY (Black OOC). Typically, the industry uses a non-productive (“NP”) master batch fill factor of around ˜75% to 80% and a rotor speed of 40 to 60 rpm.

### Example I

A design of experiment was conducted to understand the effects of a curative system on achieving similar curing speeds, low moduli at low strains, much higher elongations and high percent retention in elongation at heat ageing conditions. The design of experiment for a curative system is presented in Table 2 below.

The values “MH” and “ML” used here and throughout the description refer to “maximum torque” and “minimum torque”, respectively. The “ML (1+4)” is the Mooney viscosity value. The values of “T” are cure time in minutes. Stress/strain (tensile strength, elongation at break, modulus values, energy to break) were measured at room temperature (about 23° C.) using an Instron 4202 or an Instron Series IX Automated Materials Testing System 6.03.08. Tensile measurements were done at ambient temperature (as indicated, typically 23° C.) on specimens (dog-bone shaped) width of 0.62 cm and a length of 2.5 cm. The thickness of the specimens varied and was measured manually by Mitutoyo Digimatic Indicator connected to the system computer. The specimens were pulled at a crosshead speed of 51 cm/min and the stress/strain data was recorded. Shore A hardness was measured at room temperature (about 23° C.) by using Zwick Duromatic.

The BIIR Standard listed in Table 3 has the following formulation: 100 phr BIIR 2222, 60 phr N660, 8 phr Naphthenil Oil, 7 phr Resin 40MS, 4 phr Escorez 1102, 1 phr Stearic Acid, 0.15 phr MgO, 1 phr ZnO, 1.25 phr MBTS, 0.5 phr Sulfur, for a total phr of 182.9.

The EXXPRO MDX 03-1 Standard Formulation has the following formulation: 100 phr EXXPRO 03-1, 60 phr N660, 8 phr Naphthenil Oil, 7 phr Resin 40MS, 4 phr Escorez 1102, 1 phr Stearic Acid, 0.15 phr MgO, 1 phr ZnO, 1.25 phr MBTS, 0.5 phr Sulfur, for a total phr of 182.9.

The EXXPRO MDX 03-1 Curative System (0 phr Sulfur, 1 phr ZnO) has the following formulation: 100 phr EXXPRO 03-1, 60 phr N660, 8 phr Naphthenil Oil, 7 phr Resin 40MS, 4 phr Escorez 1102, 1 phr Stearic Acid, 0.15 phr MgO, 1 phr ZnO, 1.25 phr MBTS, for a total phr of 182.4.

The EXXPRO MDX 03-1 Curative System (0 phr Sulfur, 3 phr ZnO) has the following formulation: 100 phr EXXPRO 03-1, 60 phr N660, 8 phr Naphthenil Oil, 7 phr Resin 40MS, 4 phr Escorez 1102, 1 phr Stearic Acid, 0.15 phr MgO, 3 phr ZnO, 1.25 phr MBTS, for a total phr of 184.4.

The EXXPRO MDX 03-1 Optimized has the following formulation: 100 phr EXXPRO 03-1, 60 phr N660, 8 phr Naphthenil Oil, 7 phr Resin 40MS, 4 phr Escorez 1102, 0.5 phr Stearic Acid, 0.15 phr MgO, 2.5 phr ZnO, 2 phr MBTS, 1.17 phr Sulfur, for a total phr of 185.4.

TABLE 2
Composition Properties

| | | | EXXPRO MDX 03-1 | | | |
|---|---|---|---|---|---|---|
| | | | | Curative | Curative | |
| | | | | System (0 phr | System | |
| | | BIIR 2222 | | Sulfur, 1 phr | (0 phr Sulfur, 3 | |
| Property | Units | Standard | Standard | ZnO) | phr ZnO) | Optimized |
| Mooney (1 + 4) | MU | 54 | 56 | 60.6 | 61.6 | 60.8 |
| 100° C. | | | | | | |
| ASTM D1646 | | | | | | |
| T50 (time for 50% | Minutes | 8.4 | 14.8 | 17.0 | 16.3 | 11.5 |
| cure), 160° C. | | | | | | |
| ASTM D2084 | | | | | | |
| T90 (time for 90% | Minutes | 17.1 | 25.6 | 27.0 | 27.0 | 17.5 |
| cure), 160° C. | | | | | | |
| ASTM D2084 | | | | | | |
| MH − ML 160° C. | dNm | 4.0 | 4.4 | 3.2 | 3.3 | 3.8 |
| T50 (time for 50% | Minutes | 2.5 | 4.9 | 7.4 | 7.0 | 3.1 |
| cure), 180° C. | | | | | | |
| T90 (time for 90% | Minutes | 4.6 | 11.7 | 15.7 | 15.3 | 4.7 |
| cure), 180° C. | | | | | | |
| MH − ML 180° C. | dNm | 4.0 | 5.6 | 5.3 | 5.3 | 3.8 |
| Stress @ Break | MPa | 9.7 | 9.5 | 8.2 | 7.6 | 8.1 |
| Elongation @ Break | % | 795 | 779 | 756 | 770 | 907 |
| Energy @ Break | Joules | 9.9 | 10.8 | 9.7 | 10.5 | 12.3 |
| Hardness | Shore A | 53.6 | 53.8 | 54.8 | 53.0 | 53.6 |

### Example II

In order to address the relatively slower cure kinetics of EXXPRO®, a design of experiment for curative system was performed. In this experimentation, the following constraints were used with respect to the upper and lower bounds of the curative system or curative system: ZnO range=0.5-3 phr; Stearic acid range=0.5-3 phr; Sulfur range=0-2 phr; MBTS range=0-2 phr. The results are shown in Table 3. The results of additional experiments are shown in Tables 3A-3D, 4A-4E, 5A-5D, and 6A-6F.

TABLE 3A

| | 1 | 2 | 3 | 4 | 5 | 6 | 7 | 8 |
|---|---|---|---|---|---|---|---|---|
| Density [kg/l] | 1.095 | 1.100 | 1.099 | 1.103 | 1.087 | 1.092 | 1.091 | 1.094 |
| BROMOBUTYL | 100 | 100 | 100 | 100 | | | | |
| 2222 | | | | | | | | |
| N660 | 46 | 46 | 46 | 46 | 46 | 46 | 46 | 46 |
| CALSOL 810 | 8 | 4 | | | 8 | 4 | | |
| STRUKTOL 40 | 7 | 7 | 7 | 7 | 7 | 7 | 7 | 7 |
| MS | | | | | | | | |
| STEARIC ACI | 1 | 1 | 1 | 1 | 1 | 1 | 1 | 1 |
| 5016NF | | | | | | | | |
| ESCOREZ | 4 | 4 | | | 4 | 4 | | |
| 1102 | | | | | | | | |
| MAGLITE K | 0.15 | 0.15 | 0.15 | 0.15 | 0.15 | 0.15 | 0.15 | 0.15 |
| Vivatec 500 | | | 8 | 4 | | | 8 | 4 |
| SP-1068 | | | 4 | 4 | | | 4 | 4 |
| EXXPRO 1603 | | | | | 100 | 100 | 100 | 100 |
| Multipass level | 166.15 | 162.15 | 166.15 | 162.15 | 166.15 | 162.15 | 166.15 | 162.15 |
| KADOX 911 | 1.0 | 1.0 | 1.0 | 1.0 | 1.0 | 1.0 | 1.0 | 1.0 |
| ALTAX, | 1.25 | 1.25 | 1.25 | 1.25 | 1.25 | 1.25 | 1.25 | 1.25 |
| MBTS | | | | | | | | |
| SULFUR | 0.5 | 0.5 | 0.5 | 0.5 | 0.5 | 0.5 | 0.5 | 0.5 |
| Total phr | 168.9 | 164.9 | 168.9 | 164.0 | 168.9 | 164.9 | 168.9 | 164.9 |

Mooney ML(1 + 8)+ Stress Relax at 100° C. for 8 min with 1 min preheat and 2 min decay

| | | | | | | | | | |
|---|---|---|---|---|---|---|---|---|---|
| Mm | [MU] | 45.30 | 51.60 | 47.30 | 54.50 | 49.70 | 56.90 | 52.70 | 60.40 |
| tMm | [min.] | 7.92 | 8.00 | 7.87 | 8.00 | 7.88 | 8.00 | 7.78 | 7.95 |
| Visc@4 | [MU] | 47.0 | 53.3 | 49.3 | 56.5 | 50.3 | 57.7 | 53.4 | 61.1 |

Mooney Scorch on MV2000E at 125° C. for 60 min with a 1 min preheat

| | | | | | | | | | |
|---|---|---|---|---|---|---|---|---|---|
| Mm | [MU] | 18.70 | 21.39 | 19.56 | 22.88 | 19.71 | 23.04 | 21.46 | 24.96 |
| tMm | [min.] | 9.58 | 9.75 | 8.02 | 8.17 | 7.38 | 7.57 | 6.95 | 6.67 |
| t1 | [min.] | 24.03 | 24.14 | 16.13 | 15.70 | 42.48 | 39.38 | 20.80 | 17.78 |
| Curerate 1 | | 0.08 | 0.11 | 0.23 | 0.22 | ″ | ″ | 0.12 | 0.11 |

Mooney Scorch on MV2000E at 135° C. for 60 min with a 1 min preheat

| | | | | | | | | | |
|---|---|---|---|---|---|---|---|---|---|
| Mm | [MU] | 16.30 | 18.70 | 17.10 | 20.20 | 16.30 | 19.40 | 18.00 | 21.20 |
| tMm | [min.] | 7.75 | 7.03 | 6.47 | 5.83 | 9.67 | 8.17 | 5.97 | 6.02 |
| t1 | [min.] | 13.23 | 14.03 | 9.50 | 9.08 | 22.73 | 22.22 | 11.28 | 11.28 |
| Curerate 1 | | 0.13 | 0.22 | 0.41 | 0.43 | 0.06 | 0.07 | 0.20 | 0.19 |

| | 9 | 10 | 11 | 12 | 13 | 14 | 15 |
|---|---|---|---|---|---|---|---|
| Density [kg/l] | 1.099 | 1.104 | 1.103 | 1.107 | 1.103 | 1.095 | 1.107 |
| BROMOBUTYL | | | | | 100 | | |
| 2222 | | | | | | | |
| N660 | 46 | 46 | 46 | 46 | 46 | 46 | 46 |
| CALSOL 810 | 8 | 4 | | | 2 | 2 | 2 |
| STRUKTOL 40 | 7 | 7 | 7 | 7 | 7 | 7 | 7 |
| MS | | | | | | | |
| STEARIC ACI | 0.51 | 0.51 | 0.51 | 0.51 | 1 | 1 | 0.51 |
| 5016NF | | | | | | | |
| ESCOREZ 1102 | 4 | 4 | | | 4 | 4 | 4 |
| MAGLITE K | 0.15 | 0.15 | 0.15 | 0.15 | 0.15 | 0.15 | 0.15 |
| Vivatec 500 | | | 8 | 4 | | | |
| SP-1068 | | | 4 | 4 | | | |
| EXXPRO 1603 | 100 | 100 | 100 | 100 | | 100 | 100 |
| Multipass level | 165.66 | 161.66 | 165.66 | 161.66 | 160.15 | 160.15 | 159.66 |
| KADOX 911 | 2.57 | 2.57 | 2.57 | 2.57 | 1.0 | 1.0 | 2.57 |
| ALTAX, MBTS | 2.0 | 2.0 | 2.0 | 2.0 | 1.25 | 1.25 | 2.0 |
| SULFUR | 1.10 | 1.10 | 1.1 | 1.1 | 0.5 | 0.5 | 1.1 |
| Total phr | 171.3 | 167.3 | 171.3 | 167.3 | 162.9 | 162.9 | 165.3 |

Mooney ML(1 + 8)+ Stress Relax at 100° C. for 8 min with 1 min preheat and 2 min decay

| | | | | | | | | |
|---|---|---|---|---|---|---|---|---|
| Mm | [MU] | 60.40 | 50.30 | 58.30 | 56.90 | 61.50 | 56.20 | 61.50 |
| tMm | [min.] | 7.95 | 8.00 | 7.67 | 7.98 | 8.00 | 8.00 | 7.83 |
| Visc@4 | [MU] | 61.1 | 51.4 | 59.5 | 59.0 | 62.8 | 57.7 | 62.3 |

Mooney Scorch on MV2000E at 125° C. for 60 min with a 1 min preheat

| | | | | | | | | |
|---|---|---|---|---|---|---|---|---|
| Mm | [MU] | 19.36 | 23.12 | 24.01 | 25.50 | 23.47 | 25.16 | 25.41 |
| tMm | [min.] | 9.07 | 10.53 | 8.17 | 7.92 | 9.57 | 7.53 | 14.70 |
| t1 | [min.] | 36.30 | 41.05 | 16.78 | 17.28 | 25.95 | 39.12 | 39.28 |
| Curerate 1 | | ″ | 0.05 | 0.19 | 0.16 | 0.11 | ″ | 0.05 |

Mooney Scorch on MV2000E at 135° C. for 60 min with a 1 min preheat

| | | | | | | | | |
|---|---|---|---|---|---|---|---|---|
| Mm | [MU] | 15.90 | 19.20 | 21.10 | 21.30 | 20.20 | 21.40 | 21.50 |
| tMm | [min.] | 9.77 | 9.02 | 6.28 | 6.88 | 6.52 | 9.10 | 8.12 |
| t1 | [min.] | 23.80 | 21.03 | 10.13 | 11.08 | 12.83 | 22.67 | 18.67 |
| Curera 1 | | 0.09 | 0.10 | 0.37 | 0.27 | 0.24 | 0.06 | 0.09 |

TABLE 3B
MDR times by 10's at 160° C. for 30 min with a Osc. Angle at 0.5 Degrees

| | | | | | | | | | |
|---|---|---|---|---|---|---|---|---|---|
| ML | [dNm] | 1.02 | 1.23 | 1.04 | 1.27 | 0.95 | 1.16 | 1.02 | 1.24 |
| MH | [dNm] | 4.12 | 4.60 | 3.80 | 4.46 | 5.35 | 5.82 | 5.14 | 6.03 |
| MH − ML | [dNm] | 3.10 | 3.37 | 2.76 | 3.19 | 4.40 | 4.66 | 4.12 | 4.79 |
| ts1 | [MIn] | 4.69 | 4.41 | 3.43 | 3.32 | 8.83 | 8.69 | 5.32 | 4.89 |
| PeakRate | [dNm/min] | 0.64 | 0.62 | 0.66 | 0.67 | 0.52 | 0.48 | 0.61 | 0.62 |
| PeakTime | [Min] | 5.14 | 4.86 | 3.35 | 3.65 | 12.21 | 12.35 | 7.83 | 7.85 |
| tMH | [Min] | 26.25 | 29.82 | 29.85 | 29.85 | 29.89 | 29.85 | 29.98 | 29.92 |

MDR times by 10's at 180° C. for 30 min with a 0.5degree osc. Angle.

| | | | | | | | | | |
|---|---|---|---|---|---|---|---|---|---|
| told | [dNm] | 0.82 | 0.97 | 0.83 | 1.01 | 0.72 | 0.88 | 0.77 | 0.94 |
| MH | [dNm] | 3.89 | 4.31 | 3.49 | 4.10 | 5.19 | 5.71 | 4.85 | 5.66 |
| MH − ML | [dNm] | 3.07 | 3.34 | 2.66 | 3.09 | 4.47 | 4.83 | 4.08 | 4.72 |
| ts1 | [MIn] | 1.56 | 1.49 | 1.33 | 1.24 | 2.87 | 2.81 | 1.99 | 1.89 |
| PeakRate | [dNm/min] | 1.62 | 1.66 | 1.57 | 1.78 | 1.42 | 1.44 | 1.78 | 1.97 |
| PeakTime | [Min] | 1.84 | 1.69 | 1.32 | 1.38 | 3.27 | 3.72 | 2.58 | 2.45 |
| tMH | [Min] | 7.33 | 7.12 | 9.06 | 8.74 | 16.79 | 16.73 | 8.87 | 10.04 |

MDR times by 10's at 160° C. for 60 min at a 0.5 degree osc. angle

| | | | | | | | | | |
|---|---|---|---|---|---|---|---|---|---|
| ML | [dNm] | 1.13 | 1.28 | 1.10 | 1.28 | 0.99 | 1.17 | 1.01 | 1.25 |
| MH | [dNm] | 4.42 | 4.83 | 4.02 | 4.64 | 5.72 | 6.21 | 5.24 | 6.10 |
| MH | − ML [dNm] | 3.29 | 3.55 | 2.92 | 3.36 | 4.73 | 5.04 | 4.23 | 4.85 |
| ts1 | [MIn] | 4.41 | 4.08 | 3.32 | 3.11 | 8.67 | 8.38 | 5.21 | 4.85 |
| PeakRate | [dNm/min] | 0.60 | 0.67 | 0.72 | 0.71 | 0.53 | 0.53 | 0.71 | 0.68 |
| PeakTime | [Min] | 4.97 | 5.41 | 3.53 | 3.39 | 12.22 | 10.81 | 6.82 | 7.57 |
| tMH | [Min] | 32.40 | 26.44 | 41.40 | 48.57 | 59.76 | 51.0 | 30.63 | 28.24 |

Green Strength
(Tire Method)

| | | | | | | | | | |
|---|---|---|---|---|---|---|---|---|---|
| 100 Modulus | [MPa] | 0.29 | 0.32 | 0.29 | 0.33 | 0.36 | 0.43 | 0.47 | 0.46 |
| PeakLoad | [N] | 8.15 | 8.79 | 8.802 | 10.91 | 10.55 | 14.17 | 14.55 | 16.35 |
| PeakStress | [MPa] | 0.29 | 0.32 | 0.294 | 0.33 | 0.36 | 0.43 | 0.48 | 0.46 |
| StrnAtPeak | [%] | 84.57 | 77.48 | 79.98 | 72.90 | 76.65 | 85.40 | 92.48 | 85.81 |
| Ld@100Str | [N] | 8.08 | 8.74 | 8.72 | 10.69 | 10.44 | 14.12 | 14.50 | 16.21 |
| Strs@StrnEnd | [MPa] | 0.29 | 0.32 | 0.29 | 0.33 | 0.360 | 0.43 | 0.47 | 0.46 |
| StrTime75 | [min] | 5.12 | 3.95 | 6.44 | 4.61 | 5.271 | 3.14 | 5.31 | 3.16 |
| TimeTo75 | [min] | 5.07 | 3.98 | 6.36 | 4.38 | 5.18 | 3.16 | 5.23 | 3.19 |
| ML | [dNm] | | 1.0 | 1.2 | 1.0 | 1.2 | 1.3 | 1.3 | 1.3 |
| MH | [dNm] | | 4.3 | 4.8 | 4.2 | 4.8 | 5.0 | 6.0 | 5.0 |
| MH − ML | [dNm] | | 3.3 | 3.6 | 3.2 | 3.6 | 3.6 | 4.7 | 3.7 |
| ts1 | [MIn] | | 7.9 | 7.4 | 4.7 | 4.4 | 4.2 | 8.5 | 7.1 |
| PeakRate | [dNm/min] | | 0.5 | 0.6 | 0.6 | 0.7 | 0.7 | 0.5 | 0.5 |
| PeakTime | [Min] | | 10.1 | 10.0 | 6.1 | 6.7 | 5.6 | 11.9 | 11.4 |
| tMH | [Min] | | 24.4 | 20.7 | 16.8 | 20.0 | 29.2 | 30.0 | 21.7 |

MDR times by 10's at 180° C. for 30 min with a 0.5degree osc. Angle.

| | | | | | | | | |
|---|---|---|---|---|---|---|---|---|
| MH | [dNm] | 3.92 | 4.39 | 3.89 | 4.44 | 4.73 | 6.06 | 4.62 |
| MH − ML | [dNm] | 3.20 | 3.48 | 3.08 | 3.51 | 3.64 | 5.08 | 3.60 |
| ts1 | [MIn] | 2.49 | 2.39 | 1.73 | 1.69 | 1.48 | 2.71 | 2.34 |
| PeakRate | [dNm/min] | 1.76 | 1.79 | 1.77 | 1.91 | 1.78 | 1.50 | 1.81 |
| PeakTime | [Min] | 2.88 | 3.00 | 2.40 | 2.29 | 1.81 | 3.39 | 2.97 |
| tMH | [Min] | 6.30 | 6.55 | 5.79 | 5.74 | 6.36 | 15.07 | 6.93 |

MDR times by 10's at 160° C. for 60 min at a 0.5 degree osc. angle

| | | | | | | | | |
|---|---|---|---|---|---|---|---|---|
| ML | [dNm] | 0.97 | 1.20 | 1.05 | 1.23 | 1.36 | 1.28 | 1.31 |
| MH | [dNm] | 4.33 | 4.78 | 4.25 | 4.85 | 5.01 | 6.32 | 5.04 |
| MH − ML | [dNm] | 3.36 | 3.58 | 3.20 | 3.62 | 3.65 | 5.04 | 3.73 |
| ts1 | [MIn] | 7.82 | 7.15 | 4.66 | 4.41 | 4.17 | 8.29 | 6.90 |
| PeakRate | [dNm/min] | 0.52 | 0.59 | 0.59 | 0.61 | 0.64 | 0.49 | 0.54 |
| PeakTime | [Min] | 10.66 | 9.00 | 6.70 | 6.15 | 5.55 | 16.36 | 9.45 |
| tMH | [Min] | 24.46 | 22.95 | 15.79 | 17.22 | 27.17 | 47.29 | 24.63 |

Green Strength (Tire Method)

| | | | | | | | | |
|---|---|---|---|---|---|---|---|---|
| 100 Modulus | [MPa] | 0.40 | 0.47 | 0.53 | 0.63 | 0.25 | 0.41 | 0.44 |
| PeakLoad | [N] | 15.84 | 18.66 | 20.84 | 27.11 | 10.29 | 15.81 | 14.77 |
| PeakStress | [MPa] | 0.41 | 0.47 | 0.53 | 0.63 | 0.25 | 0.41 | 0.44 |
| StrnAtPeak | [%] | 81.23 | 92.48 | 99.57 | 99.98 | 99.57 | 99.57 | 99.98 |
| Ld@100Str | [N] | 15.63 | 18.48 | 20.84 | 27.11 | 10.27 | 15.76 | 14.75 |
| Strs@ StrnEnd | [MPa] | 0.40 | 0.47 | 0.53 | 0.63 | 0.25 | 0.41 | 0.44 |
| StrTime75 | [min] | 4.10 | 5.49 | 10.42 | 10.82 | 1.23 | 2.54 | 3.99 |
| TimeTo75 | [min] | 4.04 | 5.47 | 10.42 | 10.82 | 1.23 | 2.51 | 3.99 |

TABLE 3C
Hardness Shore A (Zwick) Test Delay (3 sec.) Aged 160° C.

| | | | | | | | | | |
|---|---|---|---|---|---|---|---|---|---|
| Hardness A | [Shore A] | 51 | 51 | 46 | 49 | 57 | 58 | 54 | 57 |

Hardness Shore A (Zwick) Test Delay (3 sec.) Unaged 160° C.

| | | | | | | | | | |
|---|---|---|---|---|---|---|---|---|---|
| Hardness A | [Shore A] | 37 | 40 | 36 | 40 | 45 | 47 | 45 | 48 |

Hardness Shore A (Zwick) Test Delay (3 sec.) Aged 3 Day's @ 125° C. Cured @ 175° C.

| | | | | | | | | | |
|---|---|---|---|---|---|---|---|---|---|
| Hardness A | [Shore A] | 34 | 35 | 33 | 36 | 45 | 47 | 44 | 49 |

Hardness Shore A (Zwick) Test Delay (3 sec.) Unaged 3 Day's @ 125° C. Cured @ 175° C.

| | | | | | | | | | |
|---|---|---|---|---|---|---|---|---|---|
| Hardness A | [Shore A] | 33 | 36 | 34 | 38 | 44 | 47 | 43 | 48 |

Tensile 1000 Test Aged 3 day's 125° C.

| | | | | | | | | | |
|---|---|---|---|---|---|---|---|---|---|
| 10 Modulus | [MPa] | 0.469 | 0.499 | 0.379 | 0.368 | 0.545 | 0.543 | 0.453 | 0.540 |
| 500 Modulus | [MPa] | 6.524 | 6.616 | 5.455 | 6.407 | 9.849 | 10.581 | 8.887 | 10.171 |
| EnergyToBreak | [J] | 6.806 | 7.197 | 7.077 | 7.261 | 10.374 | 10.772 | 10.317 | 11.054 |
| StressAtBreak | [MPa] | 7.216 | 7.419 | 6.404 | 7.086 | 10.432 | 11.419 | 10.228 | 11.082 |
| % StrainAtBreak | [%] | 592.480 | 584.460 | 620.940 | 572.570 | 564.590 | 556.640 | 586.510 | 565.820 |

Unaged Tensile 1000 Test Cured @ 175° C.

| | | | | | | | | | |
|---|---|---|---|---|---|---|---|---|---|
| 10 Modulus | [MPa] | 0.261 | 0.298 | 0.299 | 0.303 | 0.347 | 0.370 | 0.347 | 0.402 |
| 500 Modulus | [MPa] | 4.431 | 5.286 | 4.271 | 5.763 | 6.735 | 7.478 | 6.364 | 7.463 |
| EnergyToBreak | [J] | 8.994 | 10.255 | 10.407 | 9.100 | 10.436 | 10.911 | 8.481 | 12.232 |
| StressAtBreak | [MPa] | 8.954 | 10.554 | 9.964 | 9.575 | 9.407 | 9.979 | 8.212 | 10.436 |
| % StrainAtBreak | [%] | 768.460 | 750.330 | 817.400 | 706.41 | 712.660 | 689.820 | 644.810 | 722.530 |

Tensile 1000 Test Aged 3 day's 125° C. Cured @ 160° C.

| | | | | | | | | | |
|---|---|---|---|---|---|---|---|---|---|
| 10 Modulus | [MPa] | 0.413 | 0.454 | 0.377 | 0.340 | 0.506 | 0.515 | 0.459 | 0.513 |
| 500 Modulus | [MPa] | 7.181 | 7.299 | 6.235 | 6.892 | 9.445 | 10.116 | 8.534 | 9.978 |
| EnergyToBreak | [J] | 8.238 | 8.957 | 8.641 | 8.221 | 9.910 | 9.191 | 10.471 | 11.340 |
| StressAtBreak | [MPa] | 8.912 | 9.127 | 8.608 | 8.721 | 10.271 | 10.403 | 10.579 | 11.091 |
| % StrainAtBreak | [%] | 616.990 | 631.200 | 651.290 | 621.810 | 566.720 | 517.000 | 636.250 | 587.350 |

Tensile 1000 Test Unaged Cured @160° C.

| | | | | | | | | | |
|---|---|---|---|---|---|---|---|---|---|
| 10 Modulus | [MPa] | 0.434 | 0.507 | 0.442 | 0.421 | 0.518 | 0.577 | 0.549 | 0.643 |
| 500 Modulus | [MPa] | 4.976 | 5.842 | 4.800 | 5.230 | 7.533 | 8.499 | 6.580 | 8.107 |
| EnergyToBreak | [J] | 13.034 | 14.403 | 13.638 | 13.373 | 13.190 | 15.307 | 14.915 | 14.277 |
| StressAtBreak | [MPa] | 11.528 | 12.934 | 11.845 | 12.076 | 11.095 | 12.446 | 11.499 | 12.792 |
| % StrainAtBreak | [%] | 860.020 | 873.040 | 895.160 | 849.03 | 737.700 | 747.670 | 853.840 | 743.100 |

Hardness Shore A (Zwick) Test Delay (3 sec.) Aged 160° C.

| | | | | | | | | |
|---|---|---|---|---|---|---|---|---|
| Hardness A | [Shore A] | 54 | 54 | 52 | 54 | 51 | 56 | 55 |

Hardness Shore A (Zwick) Test Delay (3 sec.) Unaged 160° C.

| | | | | | | | | |
|---|---|---|---|---|---|---|---|---|
| Hardness A | [Shore A] | 42 | 45 | 44 | 45 | 40 | 49 | 47 |

Hardness Shore A (Zwick) Test Delay (3 sec.) Aged 3 Day's @ 125° C. Cured @ 175° C.

| | | | | | | | | |
|---|---|---|---|---|---|---|---|---|
| Hardness A | [Shore A] | 42 | 43 | 40 | 45 | 37 | 49 | 45 |

Hardness Shore A (Zwick) Test Delay (3 sec.) Unaged 3 Day's @ 125° C. Cured @ 175° C.

| | | | | | | | | |
|---|---|---|---|---|---|---|---|---|
| Hardness A | [Shore A] | 41 | 44 | 41 | 45 | 38 | 48 | 46 |

Tensile 1000 Test Aged 3 day's 125° C.

| | | | | | | | | |
|---|---|---|---|---|---|---|---|---|
| 10 Modulus | [MPa] | 0.580 | 0.457 | 0.436 | 0.504 | 0.406 | 0.461 | 0.502 |
| 500 Modulus | [MPa] | 7.383 | 8.295 | 7.992 | 8.704 | 6.464 | 10.645 | 7.776 |
| EnergyToBreak | [J] | 12.013 | 10.697 | 10.691 | 10.946 | 5.481 | 11.912 | 12.271 |
| StressAtBreak | [MPa] | 9.892 | 10.069 | 10.272 | 10.413 | 6.737 | 11.651 | 10.243 |
| % StrainAtBreak | [%] | 716.200 | 636.080 | 654.840 | 622.880 | 497.500 | 581.840 | 713.810 |

Unaged Tensile 1000 Test Cured @ 175° C.

| | | | | | | | | |
|---|---|---|---|---|---|---|---|---|
| 10 Modulus | [MPa] | 0.322 | 0.352 | 0.331 | 0.361 | 0.291 | 0.409 | 0.396 |
| 500 Modulus | [MPa] | 4.564 | 5.273 | 4.991 | 5.415 | 6.119 | 7.863 | 5.344 |
| EnergyToBreak | [J] | 10.380 | 11.650 | 11.962 | 12.847 | 9.998 | 12.909 | 13.476 |
| StressAtBreak | [MPa] | 7.741 | 8.937 | 9.074 | 9.357 | 10.222 | 10.851 | 9.474 |
| % StrainAtBreak | [%] | 847.260 | 839.170 | 888.480 | 853.120 | 719.720 | 723.290 | 904.220 |

Tensile 1000 Test Aged 3 day's 125° C. Cured @ 160° C.

| | | | | | | | | |
|---|---|---|---|---|---|---|---|---|
| 10 Modulus | [MPa] | 0.431 | 0.532 | 0.412 | 0.480 | 0.445 | 0.491 | 0.536 |
| 500 Modulus | [MPa] | 7.370 | 8.214 | 7.384 | 8.881 | 8.397 | 10.648 | 8.360 |
| EnergyToBreak | [J] | 11.330 | 12.407 | 12.247 | 12.608 | 9.857 | 10.850 | 13.652 |
| StressAtBreak | [MPa] | 9.992 | 10.861 | 10.570 | 11.233 | 10.083 | 11.233 | 10.779 |
| % StrainAtBreak | [%] | 704.400 | 708.880 | 724.040 | 668.360 | 611.310 | 546.940 | 696.300 |

Tensile 1000 Test Unaged Cured @160° C.

| | | | | | | | | |
|---|---|---|---|---|---|---|---|---|
| 10 Modulus | [MPa] | 0.412 | 0.592 | 0.570 | 0.554 | 0.547 | 0.634 | ″ |
| 500 Modulus | [MPa] | 5.510 | 6.066 | 5.766 | 6.681 | 6.962 | 9.174 | ″ |
| EnergyToBreak | [J] | 5.744 | 14.653 | 15.125 | 17.424 | 16.494 | 18.076 | ″ |
| StressAtBreak | [MPa] | 10.615 | 11.098 | 11.040 | 11.958 | 14.124 | 13.038 | ″ |
| % StrainAtBreak | [%] | 541.480 | 868.750 | 922.840 | 909.440 | 848.490 | 787.740 | ″ |

TABLE 3D
Die B Tear Cured @ 175° C., test temperature 23° C. at a speed of 508 mm/min

| | | | | | | | | | |
|---|---|---|---|---|---|---|---|---|---|
| Thickness | [mm] | 1.86 | 1.81 | 1.91 | 1.95 | 1.78 | 1.99 | 1.94 | 1.82 |
| PeakLoad | [N] | 63.7 | 64.0 | 58.6 | 65.6 | 68.5 | 78.8 | 76.8 | 73.0 |
| TearResistance2 | [N/mm] | 34.5 | 35.4 | 30.7 | 33.2 | 38.2 | 39.6 | 40.2 | 40.1 |

Die B Tear Cured @ 175° C. at a test temperature of 23° C. and a speed of 508 mm/min

| | | | | | | | | | |
|---|---|---|---|---|---|---|---|---|---|
| Thickness | [mm] | 1.90 | 1.87 | 1.93 | 1.99 | 1.81 | 1.98 | 1.95 | 1.84 |
| PeakLoad | [N] | 78.9 | 82.3 | 71.5 | 82.6 | 61.2 | 80.4 | 74.8 | 74.9 |
| TearResistance2 | [N/mm] | 41.5 | 43.6 | 37.0 | 41.3 | 33.8 | 41.0 | 38.4 | 40.1 |

Die B Tear, Aged 3 day's 125° C. Cured @ 160° C. at test
temperature of 23° C. and speed of 508 mm/min

| | | | | | | | | | |
|---|---|---|---|---|---|---|---|---|---|
| Thickness | [mm] | 1.84 | 1.92 | 1.93 | 1.97 | 1.85 | 1.98 | 1.90 | 2.01 |
| PeakLoad | [N] | 82.9 | 88.0 | 79.9 | 86.5 | 82.8 | 85.7 | 90.6 | 95.7 |

Die B Tear Unaged Cured @160° C. at test temperature
of 23° C. at a speed of 508 mm/min

| | | | | | | | | | |
|---|---|---|---|---|---|---|---|---|---|
| Thickness | [mm] | 1.89 | 1.88 | 1.90 | 1.85 | 1.83 | 1.83 | 1.85 | 1.98 |
| PeakLoad | [N] | 85.7 | 95.9 | 88.6 | 97.5 | 81.7 | 92.7 | 81.3 | 99.7 |
| TearResistance2 | [N/mm] | 45.4 | 50.3 | 46.0 | 52.7 | 44.0 | 50.6 | 44.2 | 50.1 |

Die B Tear Cured @ 175° C., test temperature 23° C. at a speed of 508 mm/min

| | | | | | | | | |
|---|---|---|---|---|---|---|---|---|
| Thickness | [mm] | 1.87 | 1.89 | 1.78 | 1.88 | 1.93 | 1.79 | 1.90 |
| PeakLoad | [N] | 69.4 | 76.5 | 74.8 | 84.2 | 67.0 | 68.6 | 80.9 |
| TearResistance2 | [N/mm] | 37.1 | 40.6 | 42.0 | 44.6 | 34.7 | 38.3 | 42.6 |

Die B Tear Cured @ 175° C. at a test temperature of 23° C. and a speed of 508 mm/min

| | | | | | | | | |
|---|---|---|---|---|---|---|---|---|
| Thickness | [mm] | 1.91 | 1.92 | 1.83 | 1.91 | 1.97 | 1.83 | 1.93 |
| PeakLoad | [N] | 57.8 | 70.0 | 54.6 | 70.3 | 90.0 | 72.6 | 64.6 |
| TearResistance2 | [N/mm] | 30.1 | 36.4 | 30.0 | 36.8 | 45.7 | 39.4 | 33.5 |

Die B Tear
Aged 3 day's 125° C. Cured @ 160° C. at test
temperature of 23° C. and speed of 508 mm/min

| | | | | | | | | |
|---|---|---|---|---|---|---|---|---|
| Thickness | [mm] | 1.85 | 1.89 | 2.06 | 1.95 | 1.90 | 1.89 | 1.88 |
| PeakLoad | [N] | 89.2 | 90.6 | 103.2 | 102.5 | 86.8 | 85.4 | 93.3 |

Die B Tear Unaged Cured @160° C. at test temperature
of 23° C. at a speed of 508 mm/min

| | | | | | | | | |
|---|---|---|---|---|---|---|---|---|
| Thickness | [mm] | 1.83 | 1.86 | 2.03 | 1.92 | 1.86 | 1.85 | 1.85 |
| PeakLoad | [N] | 71.9 | 81.2 | 86.7 | 93.5 | 101.5 | 93.0 | 86.8 |
| TearResistance2 | [N/mm] | 38.1 | 43.4 | 42.7 | 48.9 | 54.8 | 48.7 | 46.9 |

TABLE 4A

| | 16 | 17 | 18 | 19 | 20 | 21 | 22 | 23 | 24 | 25 |
|---|---|---|---|---|---|---|---|---|---|---|
| Density [kg/l] | 1.102 | 1.093 | 1.103 | 1.094 | 1.103 | 1.104 | 1.104 | 1.094 | 1.095 | 1.106 |
| BROMOBUTYL 2222 | 100.00 | | 100.00 | | | | | 20.00 | 20.00 | 20.00 |
| N660 | 46.00 | 46.00 | 46.00 | 46.00 | 46.00 | 46.00 | 46.00 | 46.00 | 46.00 | 46.00 |
| CALSOL 810 | 4.00 | 4.00 | 3.00 | 3.00 | 4.00 | 4.00 | 4.00 | 4.00 | 4.00 | 4.00 |
| STRUKTOL 40 MS | 7.00 | 7.00 | 7.00 | 7.00 | 7.00 | 7.00 | 7.00 | 7.00 | 7.00 | 7.00 |
| STEARIC ACID 5016NF | 1.00 | 1.00 | 1.00 | 1.00 | 0.50 | 0.50 | 0.50 | 1.00 | 1.00 | 0.50 |
| ESCOREZ 1102 | 2.00 | 2.00 | 2.00 | 2.00 | 4.00 | 2.00 | 4.00 | 4.00 | 2.00 | 2.00 |
| MAGLITE K | 0.15 | 0.15 | 0.15 | 0.15 | 0.15 | 0.15 | 0.15 | 0.15 | 0.15 | 0.15 |
| EXXPRO 1603 | | 100.00 | | 100.00 | 100.00 | 100.00 | 100.00 | 80.00 | 80.00 | 80.00 |
| Multipass level | 160.15 | 160.15 | 159.15 | 159.15 | 161.65 | 159.65 | 161.65 | 162.15 | 160.15 | 159.65 |
| KADOX 911 | 1.00 | 1.00 | 1.00 | 1.00 | 2.50 | 2.50 | 2.50 | 1.00 | 1.00 | 2.50 |
| ALTAX, MBTS | 1.25 | 1.25 | 1.25 | 1.25 | 1.75 | 1.75 | 1.98 | 1.25 | 1.25 | 1.75 |
| SULFUR | 0.50 | 0.50 | 0.50 | 0.50 | 0.80 | 0.80 | 1.10 | 0.50 | 0.50 | 0.80 |
| Total phr | 162.90 | 162.90 | 161.90 | 161.90 | 166.70 | 164.70 | 167.23 | 164.90 | 162.90 | 164.70 |

Mooney ML(1 + 8) + Stress Relax, 100° C., 8 min with 1 min Preheat and 2 min Decay

| | | | | | | | | | | | |
|---|---|---|---|---|---|---|---|---|---|---|---|
| Mm | [MU] | 49.80 | 54.10 | 52.60 | 55.60 | 52.00 | 54.80 | 52.30 | 51.60 | 54.90 | 57.00 |
| tMm | [min.] | 8.00 | 7.88 | 8.00 | 7.93 | 7.97 | 8.00 | 7.68 | 7.95 | 7.97 | 8.00 |
| Visc@4 | [MU] | 51.2 | 54.8 | 54.2 | 56.4 | 52.9 | 55.5 | 53.0 | 52.4 | 55.9 | 58.1 |

Mooney Scorch on MV2000E 125° C., 60 min with 1 min Preheat

| | | | | | | | | | | | |
|---|---|---|---|---|---|---|---|---|---|---|---|
| Mm | [MU] | 19.50 | 21.20 | 21.00 | 22.10 | 19.90 | 21.10 | 19.90 | 20.10 | 21.60 | 22.20 |
| tMm | [min.] | 13.00 | 6.87 | 12.37 | 7.40 | 8.02 | 10.47 | 10.50 | 11.52 | 10.20 | 16.03 |
| t1 | [min.] | 22.28 | 23.15 | 17.65 | 12.20 | 25.68 | 28.73 | 32.28 | 28.28 | 29.32 | 30.35 |
| Curerate 1 | | 0.13 | 0.04 | 0.10 | 0.03 | 0.04 | 0.04 | 0.04 | 0.04 | 0.04 | 0.06 |

Mooney Scorch on MV2000E 135° C., 60 min with 1 min Preheat

| | | | | | | | | | | | |
|---|---|---|---|---|---|---|---|---|---|---|---|
| Mm | [MU] | 17.40 | 18.10 | 18.90 | 19.00 | 17.00 | 18.10 | 17.10 | 17.40 | 18.80 | 19.20 |
| tMm | [min.] | 7.03 | 6.15 | 7.52 | 6.33 | 7.88 | 7.92 | 7.78 | 9.12 | 7.80 | 8.68 |
| t1 | [min.] | 11.83 | 12.22 | 10.73 | 13.37 | 17.77 | 16.33 | 16.93 | 19.40 | 17.57 | 16.88 |
| Curerate 1 | | 0.23 | 0.07 | 0.22 | 0.07 | 0.09 | 0.10 | 0.11 | 0.10 | 0.10 | 0.15 |

TABLE 4B
MDR times by 10's at 160° C., 30 min with an Osc angle of 0.5Degrees

| | | | | | | | | | | | |
|---|---|---|---|---|---|---|---|---|---|---|---|
| ML | [dNm] | 1.19 | 1.16 | 1.28 | 1.19 | 1.11 | 1.16 | 1.10 | 1.10 | 1.20 | 1.23 |
| MH | [dNm] | 4.29 | 5.58 | 4.56 | 5.62 | 4.60 | 4.98 | 4.41 | 5.55 | 6.07 | 5.42 |
| MH − ML | [dNm] | 3.10 | 4.42 | 3.28 | 4.43 | 3.49 | 3.82 | 3.31 | 4.45 | 4.87 | 4.19 |
| ts1 | [MIn] | 5.16 | 9.62 | 4.67 | 9.54 | 8.70 | 8.79 | 8.21 | 8.10 | 7.77 | 6.66 |
| PeakRate | [dNm/min] | 0.45 | 0.35 | 0.52 | 0.34 | 0.40 | 0.41 | 0.43 | 0.43 | 0.42 | 0.51 |
| PeakTime | [Min] | 5.66 | 12.65 | 5.46 | 13.69 | 11.05 | 10.93 | 9.56 | 11.13 | 11.18 | 8.35 |
| tMH | [Min] | 29.51 | 29.99 | 29.97 | 30.00 | 29.97 | 29.99 | 27.04 | 29.99 | 29.98 | 29.72 |

MDR times by 10's at 160° C. at 60 min at an Osc angle of 0.5 Degrees

| | | | | | | | | | | | |
|---|---|---|---|---|---|---|---|---|---|---|---|
| ML | [dNm] | 1.16 | 1.16 | 1.27 | 1.21 | 1.1 | 1.16 | 1.08 | 1.1 | 1.21 | 1.21 |
| MH | [dNm] | 4.22 | 5.77 | 4.56 | 5.89 | 4.55 | 4.97 | 4.33 | 5.57 | 6.18 | 5.40 |
| MH − ML | [dNm] | 3.06 | 4.61 | 3.29 | 4.68 | 3.45 | 3.81 | 3.25 | 4.47 | 4.97 | 4.19 |
| ts1 | [MIn] | 5.2 | 9.7 | 4.68 | 9.49 | 8.79 | 8.8 | 8.27 | 8.18 | 7.76 | 6.69 |
| PeakRate | [dNm/min] | 0.44 | 0.34 | 0.52 | 0.34 | 0.4 | 0.4 | 0.42 | 0.43 | 0.42 | 0.50 |
| PeakTime | [Min] | 5.92 | 13.31 | 5.32 | 12.91 | 10.63 | 10.38 | 9.69 | 11.26 | 11.56 | 8.54 |
| tMH | [Min] | 29.2 | 56.83 | 35.53 | 59.33 | 31.23 | 37.56 | 27.02 | 48.98 | 47.42 | 28.96 |

MDR times by 10's at 180° C. for 30 min with a Osc. Angle of 0.5 Degrees

| | | | | | | | | | | | |
|---|---|---|---|---|---|---|---|---|---|---|---|
| ML | [dNm] | 0.96 | 0.87 | 1.04 | 0.94 | 0.83 | 0.9 | 0.84 | 0.83 | 0.93 | 0.97 |
| MH | [dNm] | 3.99 | 5.3 | 4.18 | 5.66 | 4.21 | 4.7 | 4.08 | 5.32 | 5.84 | 5.22 |
| MH − ML | [dNm] | 3.03 | 4.43 | 3.14 | 4.72 | 3.38 | 3.8 | 3.24 | 4.49 | 4.91 | 4.25 |
| ts1 | [MIn] | 1.75 | 3.04 | 1.62 | 2.94 | 2.71 | 2.74 | 2.56 | 2.53 | 2.45 | 2.11 |
| PeakRate | [dNm/min] | 1.39 | 1.23 | 1.59 | 1.33 | 1.54 | 1.59 | 1.69 | 1.56 | 1.54 | 1.99 |
| PeakTime | [Min] | 1.9 | 3.73 | 1.74 | 3.5 | 3.06 | 3.25 | 3.09 | 3.13 | 3.33 | 2.54 |
| tMH | [Min] | 7.87 | 24.3 | 7.46 | 20.66 | 8.65 | 10.38 | 7.39 | 14.35 | 13.75 | 8.43 |

TABLE 4C
Green Strength (Tire Method)

| | | | | | | | | | | | |
|---|---|---|---|---|---|---|---|---|---|---|---|
| StrainEndP | [%] | 0.306 | 0.407 | 0.309 | 0.412 | 0.379 | 0.396 | 0.381 | 0.366 | 0.37 | 0.388 |
| 100Modulus | [MPa] | 0.306 | 0.407 | 0.309 | 0.412 | 0.379 | 0.396 | 0.381 | 0.366 | 0.37 | 0.388 |
| % Str@StrEnd | [%] | 100 | 100 | 100 | 100 | 100 | 100 | 100 | 100 | 100 | 100 |
| PeakLoad | [N] | 10.474 | 12.672 | 12.365 | 15.571 | 12.534 | 14.451 | 13.722 | 12.925 | 11.177 | 12.593 |
| PeakStress | [MPa] | 0.312 | 0.412 | 0.312 | 0.417 | 0.382 | 0.402 | 0.384 | 0.369 | 0.378 | 0.397 |
| StrnAtPeak | [%] | 73.732 | 81.65 | 84.982 | 89.148 | 97.482 | 92.9 | 97.483 | 92.898 | 92.899 | 73.731 |
| Ld@100Str | [N] | 10.082 | 12.521 | 12.277 | 15.511 | 12.373 | 14.315 | 13.49 | 12.816 | 11.069 | 12.31 |
| Strs@StrnEnd | [MPa] | 0.306 | 0.407 | 0.309 | 0.412 | 0.379 | 0.396 | 0.381 | 0.366 | 0.37 | 0.388 |
| StrTime75 | [min] | 7.021 | 4.81 | 9.267 | 5.28 | 5.097 | 5.132 | 5.24 | 5.593 | 4.652 | 3.092 |
| TimeTo75 | [min] | 6.596 | 4.531 | 8.948 | 5.043 | 4.917 | 4.955 | 5.204 | 5.48 | 4.518 | 3.06 |

Unaged Hardness Shore A (Zwick) Cured @160° C. at 3 seconds at 23° C.

| | | | | | | | | | | | |
|---|---|---|---|---|---|---|---|---|---|---|---|
| Hardness A | [Shore A] | 38 | 49 | 40 | 50 | 46 | 47 | 45 | 46 | 48 | 47 |

Aged Hardness Shore A (Zwick) Cured @ 160° C. at 3 sec tested at 23° C.

| | | | | | | | | | | | |
|---|---|---|---|---|---|---|---|---|---|---|---|
| Hardness A | [Shore A] | 46 | 55 | 48 | 56 | 52 | 53 | 51 | 51 | 54 | 53 |

Unaged Hardness Shore A (Zwick) Cured @ 175° C. at 3 sec tested at 23° C.

| | | | | | | | | | | | |
|---|---|---|---|---|---|---|---|---|---|---|---|
| Hardness A | [Shore A] | 35 | 45 | 36 | 47 | 43 | 44 | 43 | 46 | 47 | 46 |

Aged Hardness Shore A (Zwick) Cured @ 175° C. at 3 sec tested at 23° C.

| | | | | | | | | | | | |
|---|---|---|---|---|---|---|---|---|---|---|---|
| Hardness A | [Shore A] | 44 | 54 | 44 | 53 | 50 | 51 | 50 | 51 | 54 | 50 |

Tensile 1000 Test 3.0 days 125° C. Cured @ 175° C.

| | | | | | | | | | | | |
|---|---|---|---|---|---|---|---|---|---|---|---|
| 10Modulus | [MPa] | 0.322 | 0.388 | 0.298 | 0.363 | 0.359 | 0.345 | 0.345 | 0.328 | 0.391 | 0.396 |
| 500Modulus | [MPa] | 4.870 | 8.206 | 5.559 | 8.581 | 6.181 | 6.610 | 5.768 | 7.565 | 8.321 | 6.934 |
| EnergyToBreak | [J] | 9.014 | 12.246 | 7.962 | 12.834 | 14.302 | 15.897 | 15.435 | 14.020 | 13.712 | 15.478 |
| StressAtBreak | [MPa] | 7.233 | 10.137 | 7.198 | 10.856 | 10.183 | 10.736 | 10.332 | 10.506 | 10.727 | 10.912 |
| % StrainAtBreak | [%] | 769.180 | 661.660 | 668.300 | 680.510 | 809.580 | 871.210 | 906.260 | 748.970 | 718.780 | 856.200 |

TABLE 4D
Tensile 1000 Test Unaged/Cured @ 175° C.

| | | | | | | | | | | | |
|---|---|---|---|---|---|---|---|---|---|---|---|
| 10Modulus | [MPa] | 0.343 | 0.465 | 0.335 | 0.405 | 0.378 | 0.423 | 0.358 | 0.422 | 0.441 | 0.424 |
| 500Modulus | [MPa] | 5.164 | 7.373 | 5.812 | 7.697 | 5.502 | 6.271 | 5.192 | 7.272 | 7.569 | 7.064 |
| EnergyToBreak | [J] | 9.119 | 12.092 | 10.571 | 11.757 | 11.737 | 12.309 | 13.706 | 12.238 | 12.227 | 11.743 |
| StressAtBreak | [MPa] | 10.503 | 10.607 | 11.363 | 10.670 | 9.808 | 10.293 | 10.265 | 10.911 | 10.913 | 10.088 |
| % StrainAtBreak | [%] | 739.700 | 707.700 | 749.820 | 700.980 | 797.220 | 792.820 | 911.280 | 715.620 | 719.520 | 728.170 |

Tensile 1000 Test 3.0 days 125° C. Cured @ 160° C.

| | | | | | | | | | | | |
|---|---|---|---|---|---|---|---|---|---|---|---|
| 10Modulus | [MPa] | 0.375 | 0.478 | 0.432 | 0.475 | 0.405 | 0.433 | 0.416 | 0.375 | 0.453 | 0.429 |
| 500Modulus | [MPa] | 5.150 | 8.139 | 5.628 | 8.518 | 6.512 | 6.915 | 6.391 | 7.984 | 8.495 | 7.413 |
| EnergyToBreak | [J] | 11.457 | 14.172 | 11.401 | 14.500 | 15.934 | 16.052 | 16.135 | 11.234 | 12.690 | 14.909 |
| StressAtBreak | [MPa] | 8.843 | 11.443 | 8.734 | 11.261 | 11.154 | 11.046 | 11.166 | 10.427 | 11.068 | 10.589 |
| % StrainAtBreak | [%] | 854.420 | 772.900 | 791.780 | 739.480 | 888.740 | 854.650 | 931.770 | 688.830 | 698.060 | 786.410 |

Tensile 1000 Test Unaged/Cured @ 160° C.

| | | | | | | | | | | | |
|---|---|---|---|---|---|---|---|---|---|---|---|
| 10Modulus | [MPa] | 0.351 | 0.609 | 0.437 | 0.447 | 0.398 | 0.451 | 0.384 | 0.445 | 0.463 | 0.433 |
| 500Modulus | [MPa] | 5.126 | 8.385 | 6.347 | 7.697 | 5.615 | 6.411 | 5.472 | 7.271 | 7.816 | 7.170 |
| EnergyToBreak | [J] | 9.957 | 11.168 | 9.608 | 12.567 | 12.455 | 13.601 | 12.688 | 10.482 | 11.032 | 12.826 |
| StressAtBreak | [MPa] | 11.087 | 10.790 | 11.175 | 10.107 | 10.329 | 10.660 | 9.815 | 10.391 | 10.735 | 10.710 |
| % StrainAtBreak | [%] | 768.080 | 668.120 | 657.180 | 715.540 | 821.770 | 799.940 | 857.990 | 687.580 | 674.020 | 745.060 |

Die B Tear at 23° C. and a speed of 508 mm/min

| | | | | | | | | | | | |
|---|---|---|---|---|---|---|---|---|---|---|---|
| Thickness | [mm] | 1.9 | 1.99 | 1.96 | 1.92 | 2.05 | 2 | 1.93 | 1.9 | 1.85 | 1.9 |
| PeakLoad | [N] | 61.435 | 71.171 | 61.672 | 66.599 | 81.369 | 78.861 | 69.978 | 65.076 | 68.232 | 78.325 |
| TearResistance2 | [N/mm] | 32.574 | 34.887 | 31.305 | 34.749 | 38.99 | 39.747 | 36.258 | 34.356 | 36.882 | 41.301 |

TABLE 4E
Die B Tear at 23° C. and speed of 508 mm/min

| | | | | | | | | | | | |
|---|---|---|---|---|---|---|---|---|---|---|---|
| Thickness | [mm] | 1.920 | 1.960 | 1.960 | 1.910 | 2.020 | 1.860 | 1.930 | 1.850 | 1.880 | 1.830 |
| PeakLoad | [N] | 78.3540 | 71.5540 | 81.0510 | 71.8740 | 62.4180 | 60.8510 | 65.2000 | 69.5100 | 77.5560 | 76.9070 |
| TearResistance2 | [N/mm] | 41.2390 | 35.9570 | 41.3520 | 37.6300 | 31.8080 | 32.8920 | 33.7830 | 37.5730 | 40.6050 | 41.3530 |

Die B Tear at 23° C. at a speed of 508 mm/min

| | | | | | | | | | | | |
|---|---|---|---|---|---|---|---|---|---|---|---|
| Thickness | [mm] | 1.920 | 1.890 | 2.040 | 1.860 | 1.900 | 2.000 | 1.890 | 1.940 | 1.940 | 1.960 |
| PeakLoad | [N] | 62.9470 | 65.5420 | 66.1750 | 63.8190 | 71.5800 | 74.3990 | 72.1350 | 64.7920 | 70.5130 | 72.9070 |
| TearResistance2 | [N/mm] | 32.6750 | 34.3430 | 32.4380 | 34.3110 | 37.6740 | 37.1990 | 38.4140 | 33.3980 | 36.3470 | 37.1970 |

Die B Tear at 23° C. at a speed of 508 mm/min

| | | | | | | | | | | | |
|---|---|---|---|---|---|---|---|---|---|---|---|
| Thickness | [mm] | 1.910 | 1.900 | 2.000 | 1.870 | 1.910 | 2.020 | 1.910 | 1.900 | 1.970 | 1.880 |
| PeakLoad | [N] | 79.8430 | 72.8800 | 85.1810 | 74.1780 | 64.4410 | 75.6650 | 66.7800 | 75.9500 | 77.4890 | 77.5000 |
| TearResistance2 | [N/mm] | 42.0230 | 38.3580 | 42.5900 | 37.9960 | 33.7390 | 37.5350 | 34.8460 | 39.9740 | 38.9390 | 41.2230 |

TABLE 5A

| | 26 | 27 | 28 | 29 | 30 | 31 | 32 | 33 | 34 | 35 | 36 | 37 |
|---|---|---|---|---|---|---|---|---|---|---|---|---|
| Density [kg/l] | 1.131 | 1.139 | 1.139 | 1.148 | 1.122 | 1.085 | 1.091 | 1.150 | 1.147 | 1.121 | 1.078 | 1.130 |
| BROMOBUTYL 2222 | 100.00 | 100.00 | | | | 80.00 | | | | | | |
| N660 | 60.00 | 60.00 | 60.00 | 60.00 | 60.00 | 48.00 | 48.00 | 60.00 | 60.00 | 60.00 | 48.00 | 60.00 |
| CALSOL 810 | 8.00 | 2.00 | 8.00 | 2.00 | 8.00 | 8.00 | 8.00 | 8.00 | 8.00 | 8.00 | 8.00 | 8.00 |
| STRUKTOL 40 MS | 7.00 | 7.00 | 7.00 | 7.00 | 7.00 | 7.00 | 7.00 | 7.00 | 7.00 | 7.00 | 7.00 | 7.00 |
| ESCOREZ 1102 | 4.00 | 4.00 | 4.00 | 4.00 | 4.00 | 4.00 | 4.00 | 4.00 | 4.00 | 4.00 | 4.00 | 4.00 |
| STEARIC ACI 5016NF | 1.00 | 1.00 | 1.00 | 1.00 | 1.00 | 1.00 | 1.00 | 0.57 | 1.00 | 2.00 | 2.00 | 1.00 |
| MAGLITE K | 0.15 | 0.15 | 0.15 | 0.15 | 0.15 | 0.15 | 0.15 | 0.15 | 0.15 | 0.15 | 0.15 | 0.15 |
| Exxpro 03-1 | | | 100.00 | 100.00 | | | 80.00 | 100.00 | 100.00 | | | 50.00 |
| EXXPRO 3433 | | | | | 100.00 | | | | | | | 50.00 |
| SMR L | | | | | | 32.00 | 32.00 | | | | 32.00 | |
| CHLOROBUTYL 1066 | | | | | | | | | | 100.00 | 80.00 | |
| Multipass level | 180.15 | 174.15 | 180.15 | 174.15 | 180.15 | 180.15 | 180.15 | 179.72 | 180.15 | 181.15 | 181.15 | 180.15 |
| KADOX 911 | 1.00 | 1.00 | 1.00 | 1.00 | 1.00 | 1.00 | 1.00 | 2.52 | 2.50 | 1.00 | 1.00 | 1.00 |
| ALTAX, MBTS | 1.25 | 1.25 | 1.25 | 1.25 | 1.25 | 1.25 | 1.25 | 2.00 | 1.50 | 1.50 | 1.50 | 1.25 |
| SULFUR(RUBBERMAKER | 0.50 | 0.50 | 0.50 | 0.50 | 0.50 | 0.50 | 0.50 | 1.17 | 0.80 | 0.50 | 0.50 | 0.50 |
| Total phr | 182.90 | 176.90 | 182.90 | 176.90 | 182.90 | 182.90 | 182.90 | 185.41 | 184.95 | 184.15 | 184.15 | 182.90 |

Mooney ML(1 + 8) + Stress Relax at a test time of 8 min, pre heat 1 min and decay 2 min at 100° C.

| | | | | | | | | | | | | | |
|---|---|---|---|---|---|---|---|---|---|---|---|---|---|
| Mm | [MU] | 52.44 | 64.02 | 54.47 | 68.89 | 59.28 | 44.58 | 48.34 | 55.06 | 55.99 | 55.84 | 48.26 | 56.81 |
| tMm | [min.] | 7.93 | 7.63 | 6.63 | 6.62 | 7.12 | 7.98 | 7.15 | 7.65 | 7.05 | 7.55 | 7.62 | 6.60 |
| Visc@4 | [MU] | 53.6 | 65.2 | 54.9 | 69.6 | 60.0 | 45.9 | 48.9 | 56.0 | 56.8 | 56.6 | 49.1 | 57.5 |

TABLE 5B
Mooney Scorch on MV2000E with a test temperature 125° C., time of 60 min and preheat 1 min

| | | | | | | | | | | | | | |
|---|---|---|---|---|---|---|---|---|---|---|---|---|---|
| Mm | [MU] | 22.25 | 27.39 | 21.66 | 28.31 | 24.18 | 18.88 | 18.48 | 20.59 | 21.60 | 23.18 | 19.85 | 23.15 |
| tMm | [min.] | 6.18 | 6.10 | 5.58 | 6.50 | 5.90 | 5.68 | 7.33 | 7.58 | 11.00 | 7.62 | 9.98 | 5.85 |
| t1 | [min.] | 11.98 | 16.17 | 22.45 | 25.04 | 23.61 | 10.48 | 29.92 | 28.80 | 37.22 | 32.38 | 26.57 | 28.56 |
| Curerate 1 | | 0.24 | 0.12 | 0.04 | 0.04 | 0.04 | 0.30 | 0.08 | 0.05 | ″ | 0.06 | 0.18 | 0.04 |

Mooney Scorch on MV2000E at a test temperature of 135° C., test time 60 min, preheat 1 min

| | | | | | | | | | | | | | |
|---|---|---|---|---|---|---|---|---|---|---|---|---|---|
| Mm | [MU] | 21.31 | 26.31 | 20.15 | 26.40 | 22.54 | 17.91 | 17.43 | 19.21 | 19.93 | 22.46 | 20.30 | 20.23 |
| tMm | [min.] | 5.12 | 4.80 | 5.88 | 5.88 | 6.40 | 3.88 | 7.05 | 6.28 | 8.55 | 7.57 | 6.35 | 7.35 |
| t1 | [min.] | 10.71 | 11.42 | 18.48 | 19.70 | 18.35 | 6.51 | 17.11 | 19.38 | 23.15 | 20.58 | 15.63 | 17.22 |
| Curerate 1 | | 0.22 | 0.26 | 0.05 | 0.07 | 0.05 | 0.65 | 0.19 | 0.07 | 0.07 | 0.11 | 0.21 | 0.35 |

MDR times by 10's at a test time of 60 min, test temperature 160° C., and osc angle 0.5 degrees

| | | | | | | | | | | | | | |
|---|---|---|---|---|---|---|---|---|---|---|---|---|---|
| ML | [dNm] | 1.46 | 1.84 | 1.25 | 1.84 | 1.48 | 1.23 | 1.15 | 1.24 | 1.27 | 1.53 | 1.34 | 1.35 |
| MH | [dNm] | 6.11 | 6.72 | 6.35 | 7.76 | 6.38 | 5.95 | 5.65 | 4.66 | 6.14 | 5.64 | 6.81 | 6.35 |
| MH − ML | [dNm] | 4.65 | 4.88 | 5.10 | 5.92 | 4.90 | 4.72 | 4.50 | 3.42 | 4.87 | 4.11 | 5.47 | 5.00 |
| ts1 | [MIn] | 4.90 | 4.34 | 9.21 | 8.26 | 10.23 | 5.49 | 5.67 | 8.45 | 6.43 | 4.77 | 4.95 | 9.54 |
| PeakRate | [dNm/min] | 0.43 | 0.54 | 0.28 | 0.37 | 0.25 | 0.39 | 0.40 | 0.40 | 0.32 | 0.63 | 0.63 | 0.28 |
| PeakTime | [Min] | 6.53 | 6.21 | 12.63 | 13.41 | 13.29 | 6.79 | 6.51 | 11.14 | 11.06 | 6.09 | 7.46 | 14.16 |
| tMH | [Min] | 26.93 | 29.19 | 59.95 | 59.99 | 59.93 | 33.26 | 60.00 | 28.91 | 59.97 | 27.38 | 26.75 | 59.99 |

TABLE 5C
MDR times by 10's at a test time of 30 min, test temperature 160° C., and osc. Angle of 0.5 degrees

| | | | | | | | | | | | | | |
|---|---|---|---|---|---|---|---|---|---|---|---|---|---|
| ML | [dNm] | 1.52 | 1.82 | 1.28 | 1.69 | 1.47 | 1.25 | 1.19 | 1.25 | 1.27 | 1.53 | 1.36 | 1.33 |
| MH | [dNm] | 6.18 | 6.64 | 5.75 | 6.98 | 5.56 | 6.04 | 5.36 | 4.90 | 5.89 | 5.67 | 6.86 | 5.79 |
| MH − ML | [dNm] | 4.66 | 4.82 | 4.47 | 5.29 | 4.09 | 4.79 | 4.17 | 3.65 | 4.62 | 4.14 | 5.50 | 4.46 |
| ts1 | [MIn] | 4.84 | 4.34 | 8.95 | 7.82 | 9.74 | 5.56 | 5.67 | 7.73 | 8.32 | 4.59 | 4.99 | 9.33 |
| PeakRate | [dNm/min] | 0.47 | 0.57 | 0.29 | 0.36 | 0.26 | 0.40 | 0.41 | 0.44 | 0.38 | 0.65 | 0.68 | 0.31 |
| PeakTime | [Min] | 6.47 | 5.88 | 11.90 | 11.55 | 13.30 | 7.46 | 6.70 | 10.17 | 10.63 | 5.82 | 7.40 | 13.58 |
| tMH | [Min] | 27.49 | 28.95 | 29.96 | 29.99 | 30.00 | 29.92 | 30.00 | 27.23 | 29.94 | 29.90 | 26.15 | 29.98 |

MDR times by 10's at a test time of 30 min, test temperature of 180° C., and osc. Angle of 0.5 degrees

| | | | | | | | | | | | | | |
|---|---|---|---|---|---|---|---|---|---|---|---|---|---|
| ML | [dNm] | 1.31 | 1.59 | 1.01 | 1.31 | 1.15 | 1.01 | 0.91 | 0.94 | 0.98 | 1.20 | 1.11 | 1.05 |
| MH | [dNm] | 5.96 | 6.53 | 6.31 | 6.94 | 6.05 | 5.74 | 5.21 | 4.34 | 5.62 | 4.92 | 6.19 | 5.94 |
| MH − ML | [dNm] | 4.65 | 4.94 | 5.30 | 5.63 | 4.90 | 4.73 | 4.30 | 3.40 | 4.64 | 3.72 | 5.08 | 4.89 |
| ts1 | [MIn] | 1.52 | 1.41 | 2.59 | 2.53 | 2.99 | 1.66 | 1.69 | 2.44 | 2.48 | 1.46 | 1.59 | 2.86 |
| PeakRate | [dNm/min] | 1.91 | 2.16 | 1.17 | 1.36 | 1.03 | 1.88 | 1.34 | 1.75 | 1.51 | 2.20 | 2.59 | 1.19 |
| PeakTime | [Min] | 2.14 | 1.96 | 3.24 | 3.58 | 3.53 | 2.07 | 1.87 | 2.93 | 3.01 | 1.75 | 2.05 | 3.34 |
| tMH | [Min] | 6.41 | 7.50 | 22.45 | 16.67 | 27.98 | 7.32 | 29.99 | 8.23 | 14.60 | 8.14 | 6.30 | 21.55 |

TABLE 5D
Hardness Shore A (Zwick) at test temperature of 23° C. and time of 3 sec

| | | | | | | | |
|---|---|---|---|---|---|---|---|
| Hardness A | [Shore A] | 50 | 56 | 58 | 62 | 54 | 51 |

Hardness Shore A (Zwick) Test Delay (3 sec.) Aged 3-Day's @ 125° C. with test temperature of 23° C. at 3 sec

| | | | | | | | |
|---|---|---|---|---|---|---|---|
| Hardness A | [Shore A] | 64 | 64 | 70 | 70 | 66 | 70 |

Die B Tear 3-Day's @ 125° C. with test speed of 508 mm/min and test temperature of 23° C.

| | | | | | | | |
|---|---|---|---|---|---|---|---|
| Thickness | [mm] | 1.890 | 1.900 | 1.480 | 1.480 | 1.860 | 1.840 |
| PeakLoad | [N] | 92.6530 | 100.1200 | 80.8730 | 87.3700 | 115.0900 | 75.7230 |
| TearResistance2 | [N/mm] | 49.0230 | 52.6930 | 54.6440 | 59.3620 | 62.0010 | 40.9310 |

Die B Tear 3-Day's @ 125° C. with test speed of 508 mm/min and test temperature of 23° C.

| | | | | | | | |
|---|---|---|---|---|---|---|---|
| Thickness | [mm] | 1.890 | 1.900 | 1.440 | 1.470 | 1.910 | 1.870 |
| PeakLoad | [N] | 106.3400 | 114.6000 | 80.2870 | 90.6660 | 114.7200 | 103.0400 |
| TearResistance2 | [N/mm] | 55.9450 | 60.3170 | 54.6170 | 61.6780 | 60.0630 | 54.7130 |

Tensile 1000 Test Aged 3-Day's @ 125° C.

| | | | | | | | |
|---|---|---|---|---|---|---|---|
| 10Modulus | [MPa] | 0.630 | 0.577 | 0.664 | 0.572 | 0.582 | 0.776 |
| 500Modulus | [MPa] | 0.000 | 9.265 | 0.000 | 0.000 | 10.645 | 0.000 |
| StressAtBreak | [MPa] | 9.531 | 9.650 | 10.489 | 11.812 | 11.087 | 7.085 |
| % StrainAtBreak | [%] | 481.940 | 514.580 | 429.410 | 460.530 | 554.900 | 398.700 |

Tensile 1000 Test

| | | | | | | | |
|---|---|---|---|---|---|---|---|
| 10Modulus | [MPa] | 0.361 | 0.430 | 0.398 | 0.446 | 0.356 | 0.346 |
| 500Modulus | [MPa] | 7.426 | 7.469 | 7.428 | 9.270 | 7.181 | 8.067 |
| EnergyToBreak | [J] | 12.626 | 15.139 | 8.550 | 10.077 | 12.694 | 10.636 |
| StressAtBreak | [MPa] | 10.775 | 11.050 | 9.115 | 10.614 | 9.555 | 11.187 |
| % StrainAtBreak | [%] | 763.540 | 816.840 | 700.710 | 664.110 | 777.250 | 665.000 |

Hardness Shore A (Zwick) at test temperature of 23° C. and time of 3 sec

| | | | | | | | |
|---|---|---|---|---|---|---|---|
| Hardness A | [Shore A] | 52 | 55 | 57 | 47 | 52 | 57 |

Hardness Shore A (Zwick) Test Delay (3 sec.) Aged 3-Day's @ 125° C. with test temperature of 23° C. at 3 sec

| | | | | | | | |
|---|---|---|---|---|---|---|---|
| Hardness A | [Shore A] | 69 | 67 | 64 | 63 | 86 | 69 |

Die B Tear 3-Day's @ 125° C. with test speed of 508 mm/min and test temperature of 23° C.

| | | | | | | | |
|---|---|---|---|---|---|---|---|
| Thickness | [mm] | 1.890 | 1.430 | 1.840 | 1.420 | 1.420 | 1.830 |
| PeakLoad | [N] | 97.0980 | 90.0500 | 109.8500 | 58.5670 | 45.0450 | 109.8100 |
| TearResistance2 | [N/mm] | 51.2530 | 62.9720 | 59.7000 | 41.2440 | 32.1750 | 58.7230 |

Die B Tear 3-Day's @ 125° C. with test speed of 508 mm/min and test temperature of 23° C.

| | | | | | | | |
|---|---|---|---|---|---|---|---|
| Thickness | [mm] | 1.900 | 1.470 | 1.880 | 1.490 | 1.480 | 1.870 |
| PeakLoad | [N] | 97.9570 | 79.0900 | 106.7500 | 83.4690 | 76.1040 | 110.0000 |
| TearResistance2 | [N/mm] | 51.5560 | 53.8030 | 57.0870 | 55.2770 | 53.2200 | 58.2010 |

Tensile 1000 Test Aged 3-Day's @ 125° C.

| | | | | | | | |
|---|---|---|---|---|---|---|---|
| 10Modulus | [MPa] | 0.725 | 0.585 | 0.622 | 0.526 | 2.964 | 0.643 |
| 500Modulus | [MPa] | 0.000 | 8.527 | 10.628 | 0.000 | 0.000 | 10.296 |
| StressAtBreak | [MPa] | 9.208 | 9.829 | 10.950 | 6.093 | 5.429 | 10.683 |
| % StrainAtBreak | [%] | 385.870 | 620.370 | 527.490 | 362.970 | 272.230 | 545.430 |

Tensile 1000 Test

| | | | | | | | |
|---|---|---|---|---|---|---|---|
| 10Modulus | [MPa] | 0.383 | 0.344 | 0.334 | 0.310 | 0.356 | 0.361 |
| 500Modulus | [MPa] | 7.143 | 5.191 | 7.467 | 5.804 | 7.434 | 7.015 |
| EnergyToBreak | [J] | 7.815 | 9.754 | 12.531 | 6.154 | 7.979 | 10.182 |
| StressAtBreak | [MPa] | 8.210 | 8.587 | 9.398 | 7.977 | 10.419 | 8.722 |
| % StrainAtBreak | [%] | 593.970 | 913.340 | 750.930 | 681.450 | 692.030 | 690.770 |

TABLE 6A

| | 38 | 39 | 40 | 41 | 42 | 43 | 44 | 45 |
|---|---|---|---|---|---|---|---|---|
| Density [kg/l] | 1.122 | 1.130 | 1.131 | 1.133 | 1.132 | 1.124 | 1.132 | 1.131 |
| Exxpro 1603 | 100.00 | 100.00 | 100.00 | 100.00 | 100.00 | 100.00 | 100.00 | 100.00 |
| N660 (GPF)- Carbon | 60.00 | 60.00 | 60.00 | 60.00 | 60.00 | 60.00 | 60.00 | 60.00 |
| Black | | | | | | | | |
| CALSOL 810 | 8.00 | 8.00 | 8.00 | 8.00 | 8.00 | 8.00 | 8.00 | 8.00 |
| (NAPHTHENIC OIL) | | | | | | | | |
| STRUKTOL 40MS | 7.00 | 7.00 | 7.00 | 7.00 | 7.00 | 7.00 | 7.00 | 7.00 |
| HOMOGENIZING AID | | | | | | | | |
| HYSTRENE 5016-N.F. | 1.00 | 1.00 | 1.00 | 0.50 | 0.50 | 0.50 | 0.50 | 0.50 |
| ESCOREZ 1102 | 4.00 | 4.00 | 4.00 | 4.00 | 4.00 | 4.00 | 4.00 | 4.00 |
| MAGLITE K | 0.15 | 0.15 | 0.15 | 0.15 | 0.15 | 0.15 | 0.15 | |
| BROMOBUTYL 2222 | | | | | | | | |
| TDAE Process Oil | | | | | | | | |
| SP-1068 PHENOLIC | | | | | | | | |
| TACKIFIER | | | | | | | | |
| Multipass level | 180.15 | 180.15 | 180.15 | 179.65 | 179.65 | 179.65 | 179.65 | 179.50 |
| ZINC OXIDE | 1.00 | 2.50 | 2.50 | 2.50 | 2.50 | 1.00 | 2.50 | 2.50 |
| MBTS-ALTAX | 1.25 | 1.75 | 2.00 | 2.00 | 1.75 | 2.00 | 2.00 | 2.00 |
| SULFUR | 0.50 | 0.50 | 0.50 | 1.10 | 0.80 | 0.50 | 0.50 | 0.50 |
| Total phr | 182.90 | 184.90 | 185.15 | 185.25 | 184.70 | 183.15 | 184.65 | 184.50 |

Mooney ML(1 + 8) + Stress Relax at 100° C. for 8 min with 1 min preheat and 2 min decay

| | | | | | | | | | |
|---|---|---|---|---|---|---|---|---|---|
| Mm | [MU] | 61.40 | 64.00 | 63.60 | 62.60 | 63.20 | 62.90 | 63.50 | 61.60 |
| tMm | [min.] | 7.75 | 7.78 | 8.00 | 7.85 | 8.00 | 7.75 | 8.00 | 6.78 |
| Visc@4 | [MU] | 62.3 | 65.5 | 64.8 | 63.9 | 64.4 | 64.0 | 64.8 | 62.2 |

Mooney Scorch on MV2000E at 125° C. for 60 min with 1 min preheat

| | | | | | | | | | |
|---|---|---|---|---|---|---|---|---|---|
| Preheat | [min] | 1.00 | 1.00 | 1.00 | 1.00 | 1.00 | 1.00 | 1.00 | 1.00 |
| Mm | [MU] | 24.30 | 25.50 | 24.90 | 24.40 | 25.10 | ″ | 25.00 | 24.50 |
| tMm | [min.] | 11.07 | 14.27 | 13.25 | 15.08 | 10.12 | ″ | 15.73 | 9.75 |
| t1 | [min.] | 37.52 | 42.57 | 54.28 | 42.02 | 40.07 | ″ | 50.93 | 29.92 |
| Curerate 1 | | ″ | ″ | ″ | ″ | ″ | ″ | ″ | 0.05 |

| | | 46 | 47 | 48 | 49 | 50 | 51 | 52 |
|---|---|---|---|---|---|---|---|---|
| Density [kg/l] | | 1.122 | 1.130 | 1.141 | 1.133 | 1.143 | 1.145 | 1.146 |
| Exxpro 1603 | | 100.00 | | | | | 100.00 | 100.00 |
| N660 (GPF)- Carbon | | 60.00 | 60.00 | 60.00 | 60.00 | 60.00 | 60.00 | 60.00 |
| Black | | | | | | | | |
| CALSOL 810 | | 8.00 | 8.00 | 8.00 | | | | |
| (NAPHTHENIC OIL) | | | | | | | | |
| STRUKTOL 40MS | | 7.00 | 7.00 | 7.00 | 7.00 | 7.00 | 7.00 | 7.00 |
| HOMOGENIZING AID | | | | | | | | |
| HYSTRENE 5016-N.F. | | 1.00 | 1.00 | 0.50 | 1.00 | 1.00 | 0.50 | 0.50 |
| ESCOREZ 1102 | | 4.00 | 4.00 | 4.00 | 4.00 | | 4.00 | |
| MAGLITE K | | | 0.15 | 0.15 | 0.15 | 0.15 | 0.15 | 0.15 |
| BROMOBUTYL 2222 | | | 100.00 | 100.00 | 100.00 | 100.00 | | |
| TDAE Process Oil | | | | | 8.00 | | | |
| SP-1068 PHENOLIC | | | | | | 4.00 | | 4.00 |
| TACKIFIER | | | | | | | | |
| Multipass level | | 180.00 | 180.15 | 179.65 | 180.15 | 180.15 | 179.65 | 179.65 |
| ZINC OXIDE | | 1.00 | 1.00 | 2.50 | 1.00 | 1.00 | 2.50 | 2.50 |
| MBTS-ALTAX | | 2.00 | 1.25 | 2.00 | 1.25 | 1.25 | 2.00 | 2.00 |
| SULFUR | | 0.30 | 0.50 | 1.10 | 0.50 | 0.50 | 1.10 | 1.10 |
| Total phr | | 183.30 | 182.90 | 185.25 | 182.90 | 182.90 | 185.25 | 185.25 |
| Mooney ML(1 + 8) + Stress Relax at 100° C. for 8 min with 1 min preheat and 2 min decay | | | | | | | | |
| Mm | [MU] | 60.00 | 55.90 | 56.30 | 59.70 | 77.90 | 85.00 | 86.80 |
| tMm | [min.] | 7.72 | 7.57 | 7.98 | 8.00 | 7.97 | 7.97 | 7.82 |
| Visc@4 | [MU] | 61.0 | 57.4 | 58.0 | 61.3 | 80.1 | 86.3 | 88.3 |
| Mooney Scorch on MV2000E at 125° C. for 60 min with 1 min preheat | | | | | | | | |
| Preheat | [min] | 1.00 | 1.00 | 1.00 | 1.00 | 1.00 | 1.00 | 1.00 |
| Mm | [MU] | 24.00 | 22.30 | 22.20 | 23.80 | 32.40 | 34.60 | 37.00 |
| tMm | [min.] | 6.55 | 12.93 | 9.33 | 9.60 | 7.28 | 14.10 | 7.63 |
| t1 | [min.] | 23.47 | 35.50 | 23.00 | 32.33 | 15.68 | 41.10 | 17.08 |
| Curerate 1 | | 0.07 | 0.08 | 0.09 | 0.08 | 0.23 | ″ | 0.13 |

TABLE 6B
Mooney Scorch on MV2000E at 135° C., for 60 min and 1 min preheat

| | | | | | | | | | | | | | | | | |
|---|---|---|---|---|---|---|---|---|---|---|---|---|---|---|---|---|
| Mm | [MU] | 19.70 | 20.90 | 20.60 | 19.90 | 21.10 | 20.70 | 21.00 | 20.60 | 20.50 | 19.50 | 19.70 | 20.60 | 29.30 | 30.30 | 32.50 |
| tMm | [min.] | 9.73 | 10.53 | 9.75 | 8.45 | 7.30 | 10.07 | 7.08 | 5.63 | 4.63 | 6.75 | 5.00 | 6.80 | 5.13 | 8.25 | 5.93 |
| t1 | [min.] | 28.10 | 22.98 | 23.98 | 11.52 | 20.50 | 25.33 | 22.60 | 10.03 | 10.05 | 12.02 | 10.22 | 15.80 | 8.67 | 18.02 | 9.68 |
| Curerate 1 | | 0.06 | 0.11 | 0.11 | 0.05 | 0.09 | 0.08 | 0.07 | 0.08 | 0.13 | 0.10 | 0.20 | 0.18 | 0.46 | 0.09 | 0.31 |

MDR times by 10's at 160° C. for 30 min with 0.5 degrees osc angle

| | | | | | | | | | | | | | | | | |
|---|---|---|---|---|---|---|---|---|---|---|---|---|---|---|---|---|
| ML | [dNm] | 1.35 | 1.42 | 1.43 | 1.35 | 1.51 | 1.36 | 1.41 | 1.35 | 1.27 | 1.41 | 1.41 | 1.53 | 2.13 | 2.08 | 2.13 |
| MH | [dNm] | 5.80 | 5.25 | 4.72 | 4.93 | 5.70 | 5.00 | 4.77 | 4.47 | 4.13 | 5.61 | 6.94 | 5.69 | 6.46 | 6.60 | 6.76 |
| MH − ML | [dNm] | 4.45 | 3.83 | 3.29 | 3.58 | 4.19 | 3.64 | 3.36 | 3.12 | 2.86 | 4.20 | 5.53 | 4.16 | 4.33 | 4.52 | 4.63 |
| ts1 | [MIn] | 10.32 | 8.44 | 9.03 | 8.62 | 8.35 | 10.34 | 9.72 | 6.57 | 5.58 | 6.19 | 4.25 | 6.34 | 4.16 | 6.47 | 4.16 |
| PeakRate | [dNm/min] | 0.29 | 0.36 | 0.32 | 0.37 | 0.36 | 0.30 | 0.29 | 0.43 | 0.38 | 0.39 | 0.70 | 0.38 | 0.46 | 0.42 | 0.51 |
| PeakTime | [Min] | 15.54 | 11.04 | 12.19 | 11.13 | 11.31 | 13.65 | 13.20 | 9.15 | 8.62 | 7.78 | 5.36 | 8.06 | 5.71 | 11.93 | 7.88 |
| tMH | [Min] | 29.99 | 29.99 | 27.51 | 25.67 | 29.99 | 29.85 | 29.95 | 19.06 | 16.90 | 29.99 | 29.96 | 29.99 | 29.98 | 29.12 | 21.90 |

MDR times by 10's at 180° C. for 30 min with 0.5 degrees osc angle

| | | | | | | | | | | | | | | | | |
|---|---|---|---|---|---|---|---|---|---|---|---|---|---|---|---|---|
| ML | [dNm] | 1.10 | 1.14 | 1.13 | 1.11 | 1.10 | 1.08 | 1.17 | 1.10 | 1.00 | 1.19 | 1.22 | 1.29 | 1.78 | 1.68 | 1.85 |
| MH | [dNm] | 6.51 | 5.01 | 4.40 | 4.80 | 5.25 | 4.85 | 4.58 | 4.16 | 3.78 | 5.51 | 6.89 | 5.49 | 6.15 | 6.21 | 6.54 |
| MH − ML | [dNm] | 5.41 | 3.87 | 3.27 | 3.69 | 4.15 | 3.77 | 3.41 | 3.06 | 2.78 | 4.32 | 5.67 | 4.20 | 4.37 | 4.53 | 4.69 |
| ts1 | [MIn] | 3.02 | 2.59 | 2.78 | 2.58 | 2.53 | 3.08 | 2.87 | 2.26 | 2.08 | 1.96 | 1.43 | 1.96 | 1.50 | 2.26 | 1.58 |
| PeakRate | [dNm/min] | 1.07 | 1.53 | 1.40 | 1.69 | 1.56 | 1.29 | 1.28 | 1.62 | 1.42 | 1.49 | 3.09 | 1.41 | 1.58 | 1.87 | 2.07 |
| PeakTime | [Min] | 4.08 | 3.35 | 3.26 | 3.33 | 3.29 | 4.06 | 3.76 | 3.00 | 2.66 | 2.70 | 1.93 | 2.67 | 2.13 | 3.29 | 2.42 |
| tMH | [Min] | 23.85 | 9.21 | 8.45 | 7.50 | 11.44 | 10.90 | 8.65 | 5.58 | 5.69 | 8.05 | 9.98 | 7.94 | 9.90 | 8.36 | 6.41 |

TABLE 6C
MDR times by 10's for 60 mini at 160° C. and 0.5 degrees osc. angle

| | | | | | | | | | | | | | | | | |
|---|---|---|---|---|---|---|---|---|---|---|---|---|---|---|---|---|
| ML | [dNm] | 1.36 | 1.37 | 1.49 | 1.35 | 1.42 | 1.39 | 1.43 | 1.37 | 1.28 | 1.42 | 1.43 | 1.54 | 2.09 | 2.07 | 2.16 |
| MH | [dNm] | 6.39 | 5.05 | 7.56 | 4.85 | 5.43 | 4.96 | 4.70 | 4.49 | 4.11 | 5.72 | 7.11 | 5.73 | 6.56 | 6.46 | 6.71 |
| MH − ML | [dNm] | 5.03 | 3.68 | 6.07 | 3.50 | 4.01 | 3.57 | 3.27 | 3.12 | 2.83 | 4.30 | 5.68 | 4.19 | 4.47 | 4.39 | 4.55 |
| ts1 | [MIn] | 10.53 | 8.73 | 9.87 | 8.78 | 8.80 | 10.69 | 10.10 | 6.68 | 5.66 | 6.37 | 4.32 | 6.30 | 4.21 | 6.78 | 4.30 |
| PeakRate | [dNm/min] | 0.28 | 0.34 | 0.31 | 0.36 | 0.34 | 0.30 | 0.28 | 0.42 | 0.37 | 0.39 | 0.69 | 0.37 | 0.47 | 0.41 | 0.49 |
| PeakTime | [Min] | 15.68 | 10.58 | 15.20 | 11.36 | 11.31 | 13.25 | 13.52 | 9.17 | 8.45 | 8.53 | 6.97 | 8.91 | 5.54 | 10.92 | 7.81 |
| tMH | [Min] | 59.95 | 35.85 | 59.97 | 26.84 | 43.29 | 38.30 | 35.05 | 19.05 | 18.04 | 35.14 | 53.12 | 34.11 | 44.48 | 29.82 | 21.81 |

Hardness Shore A (Zwick) Unaged cured @ 160° C. at 3 sec and 23° C.

| | | | | | | | | | | | | | | | | |
|---|---|---|---|---|---|---|---|---|---|---|---|---|---|---|---|---|
| Hardness A | [Shore A] | 50.0 | 49.0 | 49.0 | 49.0 | 50.0 | 50.0 | 50.0 | 50.0 | 51.0 | 46.0 | 49.0 | 47.0 | 53.0 | 57.0 | 58.0 |

TABLE 6D
Hardness Shore A (Zwick) Aged cured @ 160° C. with 3 sec test time and test temperature 23° C.

| | | | | | | | | | |
|---|---|---|---|---|---|---|---|---|---|
| Hardness A | [Shore A] | 64 | 63 | 63 | 63 | 64 | 63 | 63 | 64 |

Hardness Shore A (Zwick) Unaged cured @ 175° C./15 min with test time of 3 sec and test temperature 23° C.

| | | | | | | | | | |
|---|---|---|---|---|---|---|---|---|---|
| Hardness A | [Shore A] | 52 | 48 | 46 | 48 | 47 | 47 | 47 | 47 |

Hardness Shore A (Zwick) Aged cured @ 175° C./15 min with test time of 3 sec and temperature 23° C.

| | | | | | | | | | |
|---|---|---|---|---|---|---|---|---|---|
| Hardness A | [Shore A] | 65 | 61 | 61 | 61 | 59 | 60 | 60 | 61 |

Tensile 1000 Test

| | | | | | | | | | |
|---|---|---|---|---|---|---|---|---|---|
| Aged 3 days/125° C. | | | | | | | | | |
| Cured @175° C./15 min | | | | | | | | | |
| 10Modulus | [MPa] | 0.723 | 0.646 | 0.667 | 0.691 | 0.637 | 0.650 | 0.690 | 0.693 |
| 500Modulus | [MPa] | 10.283 | 0.000 | 7.955 | 8.066 | 9.174 | 8.707 | 8.141 | 7.743 |
| EnergyToBreak | [J] | 10.559 | 8.367 | 11.588 | 8.639 | 12.574 | 12.124 | 11.650 | 12.310 |
| StressAtBreak | [MPa] | 10.563 | 8.807 | 8.920 | 8.586 | 9.414 | 9.426 | 9.131 | 8.644 |
| % StrainAtBreak | [%] | 503.500 | 490.900 | 664.440 | 569.430 | 629.280 | 622.340 | 648.990 | 685.330 |

| Hardness Shore A (Zwick) Aged cured @ 160° C. with 3 sec test time and test temperature 23° C. | | | | | | | | |
|---|---|---|---|---|---|---|---|---|
| Hardness A | [Shore A] | 64 | 60 | 61 | 53 | 62 | 63 | 66 |
| Hardness Shore A (Zwick) Unaged cured @ 175° C./15 min with test time of 3 sec and test temperature 23° C. | | | | | | | | |
| Hardness A | [Shore A] | 46 | 41 | 48 | 39 | 48 | 55 | 55 |
| Hardness Shore A (Zwick) Aged cured @ 175° C./15 min with test time of 3 sec and temperature 23° C. | | | | | | | | |
| Hardness A | [Shore A] | 59 | 55 | 58 | 48 | 60 | 63 | 65 |
| Tensile 1000 Test | | | | | | | | |
| Aged 3 days/125° C. | | | | | | | | |
| Cured @175° C./15 min | | | | | | | | |
| 10Modulus | [MPa] | 0.597 | 0.593 | 0.584 | 0.455 | 0.607 | 0.688 | 0.744 |
| 500Modulus | [MPa] | 7.516 | 0.000 | 0.000 | 0.000 | 0.000 | 9.055 | 10.207 |
| EnergyToBreak | [J] | 10.374 | 5.912 | 6.505 | 5.311 | 6.452 | 12.765 | 12.921 |
| StressAtBreak | [MPa] | 8.075 | 6.916 | 7.241 | 6.359 | 7.915 | 10.030 | 10.645 |
| % StrainAtBreak | [%] | 623.330 | 459.180 | 468.160 | 464.150 | 409.840 | 657.380 | 574.070 |

TABLE 6E
Tensile 1000 Test

| Unaged 3 Cured @ | | | | | | | | | |
|---|---|---|---|---|---|---|---|---|---|
| 175° C./15 min | | | | | | | | | |
| 10Modulus | [MPa] | 0.479 | 0.415 | 0.426 | 0.449 | 0.436 | 0.424 | 0.442 | 0.469 |
| 500Modulus | [MPa] | 7.492 | 5.886 | 4.635 | 5.016 | 6.426 | 5.313 | 4.919 | 4.878 |
| EnergyToBreak | [J] | 11.689 | 11.696 | 11.639 | 9.802 | 12.229 | 11.947 | 10.248 | 8.418 |
| StressAtBreak | [MPa] | 9.044 | 7.650 | 6.832 | 6.879 | 8.403 | 7.458 | 6.741 | 6.256 |
| % StrainAtBreak | [%] | 703.710 | 814.880 | 906.340 | 773.290 | 765.400 | 836.100 | 822.500 | 753.420 |

Tensile 1000 Test

| | | | | | | | | | |
|---|---|---|---|---|---|---|---|---|---|
| Aged 3 days/125° C. | | | | | | | | | |
| Cured @ 160° C. | | | | | | | | | |
| t-90 × 1.4 | | | | | | | | | |
| 10Modulus | [MPa] | 0.724 | 0.658 | 0.616 | 0.753 | 0.622 | 0.702 | 0.635 | 0.623 |
| 500Modulus | [MPa] | 0.000 | 9.069 | 8.001 | 8.552 | 9.099 | 9.120 | 8.523 | 7.789 |
| EnergyToBreak | [J] | 9.801 | 10.592 | 10.694 | 12.193 | 10.870 | 11.850 | 12.162 | 11.834 |
| StressAtBreak | [MPa] | 10.423 | 9.355 | 9.076 | 9.542 | 9.478 | 10.051 | 9.362 | 8.742 |
| % StrainAtBreak | [%] | 474.110 | 548.160 | 611.630 | 646.010 | 564.360 | 620.960 | 644.630 | 642.010 |

Tensile 1000 Test Unaged 3 Cured @ 160°

| | | | | | | | | | |
|---|---|---|---|---|---|---|---|---|---|
| 10Modulus | [MPa] | 0.405 | 0.418 | 0.431 | 0.435 | 0.415 | 0.398 | 0.396 | 0.438 |
| 500Modulus | [MPa] | 7.652 | 5.843 | 4.771 | 5.376 | 6.015 | 5.793 | 5.251 | 4.600 |
| EnergyToBreak | [J] | 10.575 | 12.974 | 11.937 | 12.405 | 12.455 | 12.200 | 11.347 | 12.586 |
| StressAtBreak | [MPa] | 8.901 | 8.261 | 7.026 | 7.675 | 8.324 | 8.073 | 7.449 | 6.937 |
| % StrainAtBreak | [%] | 664.280 | 824.470 | 928.880 | 859.240 | 813.470 | 857.500 | 851.190 | 951.200 |

Die B Tear Aged 3 days/Cured @ 175° C./15 min with test temperature 23° C. and speed of 508 mm/min

| | | | | | | | | | |
|---|---|---|---|---|---|---|---|---|---|
| Thickness | [mm] | 1.940 | 1.910 | 1.930 | 1.880 | 1.940 | 1.860 | 1.920 | 1.930 |
| PeakLoad | [N] | 82.2880 | 89.9220 | 82.3680 | 83.5740 | 94.9090 | 83.0610 | 90.3350 | 81.0920 |
| TearResistance2 | [N/mm] | 42.8250 | 46.1140 | 43.3170 | 44.4550 | 48.8640 | 44.6570 | 47.7960 | 42.0170 |

Die B Tear Unaged Cured @ 175° C./15 min, at speed of 508 mm/min and test temperature 23° C.

| | | | | | | | | | |
|---|---|---|---|---|---|---|---|---|---|
| Thickness | [mm] | 1.980 | 1.950 | 2.010 | 2.010 | 1.970 | 1.960 | 2.070 | 1.900 |
| PeakLoad | [N] | 82.1810 | 72.3230 | 68.1560 | 70.2790 | 79.4260 | 73.6370 | 72.7780 | 68.8470 |
| TearResistance2 | [N/mm] | 41.5050 | 35.7000 | 34.9520 | 35.1400 | 40.5240 | 37.5700 | 35.2200 | 36.2350 |

| Tensile 1000 Test | | | | | | | | |
|---|---|---|---|---|---|---|---|---|
| Unaged 3 Cured @ | | | | | | | | |
| 175° C./15 min | | | | | | | | |
| 10Modulus | [MPa] | 0.400 | 0.367 | 0.451 | 0.373 | 0.448 | 0.603 | 0.556 |
| 500Modulus | [MPa] | 3.942 | 6.241 | 6.856 | 6.468 | 8.140 | 7.384 | 7.475 |
| EnergyToBreak | [J] | 8.848 | 10.259 | 7.706 | 10.283 | 12.775 | 15.997 | 17.532 |
| StressAtBreak | [MPa] | 5.405 | 9.360 | 8.224 | 9.620 | 10.226 | 9.444 | 9.534 |
| % StrainAtBreak | [%] | 862.490 | 731.670 | 586.650 | 720.050 | 667.620 | 841.390 | 868.300 |
| Tensile 1000 Test | | | | | | | | |
| Aged 3 days/125° C. | | | | | | | | |
| Cured @ 160° C. | | | | | | | | |
| t-90 × 1.4 | | | | | | | | |
| 10Modulus | [MPa] | 0.738 | 0.573 | 0.617 | 0.477 | 0.654 | 0.646 | 0.747 |
| 500Modulus | [MPa] | 7.644 | 0.000 | 0.000 | 0.000 | 0.000 | 9.466 | 10.526 |
| EnergyToBreak | [J] | 10.894 | 6.662 | 7.968 | 6.746 | 6.769 | 14.253 | 12.195 |
| StressAtBreak | [MPa] | 8.306 | 7.852 | 8.150 | 7.638 | 8.540 | 10.489 | 11.141 |
| % StrainAtBreak | [%] | 627.460 | 448.260 | 473.050 | 487.440 | 410.090 | 651.820 | 540.090 |
| Tensile 1000 Test Unaged 3 Cured @ 160° | | | | | | | | |
| 10Modulus | [MPa] | 0.475 | 0.357 | 0.402 | 0.360 | 0.450 | 0.516 | 0.588 |
| 500Modulus | [MPa] | 4.493 | 6.981 | 7.293 | 7.058 | 8.483 | 7.386 | 7.550 |
| EnergyToBreak | [J] | 11.593 | 10.328 | 10.327 | 11.025 | 13.215 | 16.985 | 15.817 |
| StressAtBreak | [MPa] | 6.355 | 9.474 | 9.492 | 9.829 | 10.461 | 9.746 | 9.721 |
| % StrainAtBreak | [%] | 912.220 | 705.520 | 647.200 | 697.340 | 691.060 | 866.950 | 830.750 |
| Die B Tear Aged 3 days/Cured @ 175° C./15 min with test temperature 23° C. and speed of 508 mm/min | | | | | | | | |
| Thickness | [mm] | 1.910 | 1.850 | 1.870 | 1.860 | 1.920 | 2.000 | 1.980 |
| PeakLoad | [N] | 82.9470 | 73.5420 | 69.0880 | 66.7180 | 72.0660 | 99.2520 | 102.6100 |
| TearResistance2 | [N/mm] | 43.4280 | 39.3940 | 36.7290 | 35.8700 | 38.2630 | 49.6260 | 51.8090 |
| Die B Tear Unaged Cured @ 175° C./15 min, at speed of 508 mm/min and test temperature 23° C. | | | | | | | | |
| Thickness | [mm] | 2.070 | 1.840 | 1.950 | 1.870 | 2.030 | 1.960 | 1.920 |
| PeakLoad | [N] | 70.6300 | 81.0470 | 72.8810 | 86.0140 | 102.2800 | 81.2670 | 85.5450 |
| TearResistance2 | [N/mm] | 33.7940 | 43.0340 | 37.3750 | 46.7250 | 48.4760 | 41.0480 | 44.5260 |

TABLE 6F
Die B Tear Aged 3 days/Cured @ 160° C. at test temperature 23° C. and speed of 508 mm/min

| | | | | | | | | | |
|---|---|---|---|---|---|---|---|---|---|
| Thickness | [mm] | 1.970 | 2.030 | 1.850 | 1.870 | 1.900 | 2.010 | 1.920 | 1.950 |
| PeakLoad | [N] | 91.4890 | 94.1470 | 79.6890 | 72.7060 | 78.6370 | 86.7050 | 76.8520 | 84.9670 |
| TearResistance2 | [N/mm] | 47.1590 | 45.4810 | 43.0750 | 38.7800 | 40.5350 | 43.7900 | 40.0270 | 43.5730 |

Die B Tear Unaged Cured @ 160° C. at speed of 508 mm/min and test temperature of 23° C.

| | | | | | | | | | |
|---|---|---|---|---|---|---|---|---|---|
| Thickness | [mm] | 1.880 | 1.960 | 1.840 | 1.950 | 1.990 | 1.880 | 1.960 | 1.960 |
| PeakLoad | [N] | 79.0910 | 78.2360 | 65.2420 | 70.3850 | 82.6300 | 73.9620 | 73.9260 | 73.5290 |
| TearResistance2 | [N/mm] | 41.9640 | 39.3150 | 35.4580 | 36.0950 | 41.2400 | 38.3230 | 37.3790 | 37.5150 |

| Die B Tear Aged 3 days/Cured @ 160° C. at test temperature 23° C. and speed of 508 mm/min | | | | | | | | |
|---|---|---|---|---|---|---|---|---|
| Thickness | [mm] | 1.940 | 1.980 | 1.930 | 1.940 | 2.020 | 1.890 | 1.950 |
| PeakLoad | [N] | 85.2390 | 72.5480 | 73.2840 | 59.4640 | 69.8340 | 94.9240 | 108.4800 |
| TearResistance2 | [N/mm] | 43.9380 | 37.0140 | 36.6660 | 30.4950 | 34.5710 | 50.4920 | 54.7880 |
| Die B Tear Unaged Cured @ 160° C. at speed of 508 mm/min and test temperature of 23° C. | | | | | | | | |
| Thickness | [mm] | 1.960 | 1.860 | 1.890 | 1.870 | 1.880 | 2.010 | 1.990 |
| PeakLoad | [N] | 69.3710 | 78.9100 | 77.5720 | 81.2590 | 90.0660 | 88.5990 | 89.1540 |
| TearResistance2 | [N/mm] | 35.3930 | 42.1980 | 39.7800 | 42.7680 | 47.9070 | 43.8490 | 45.7200 |

We claim:

1. A curative system comprising:
(a) about 0.5 to about 3 phr metal oxide;
(b) about 0.3 to about 3 phr fatty acid;
(c) less than or equal to about 2 phr sulfur; and
(d) less than or equal to about 2 phr cure accelerator.

2. The curative system of claim 1, wherein the metal oxide is selected from the group consisting of zinc oxide, calcium oxide, magnesium oxide, aluminum oxide, chromium trioxide, iron (II) oxide, iron (III) oxide, and nickel (II) oxide.

3. The curative system of claim 1, wherein the metal oxide is zinc oxide.

4. The curative system of claim 1, wherein the fatty acid is a metal fatty acid complex selected from the group consisting of zinc stearate, calcium stearate, and magnesium stearate.

5. The curative system of claim 1, wherein the fatty acid is stearic acid.

6. The curative system of claim 1, wherein the cure accelerator is selected from the group consisting of diphenyl guanidine, tetramethylthiram disulfide, 4-4′-diothiodimorpholine, tetrabutylthiram disulfide, benzothiazyl disulfide, hexamethylene-1,6-bisthiosulfate disodium salt dehydrate, 2-morpholinothio benzothiazole, N-tertiary-butyl-2-benzothiazole sulfonamide, N-oxydiethylene thiocarbanyl-N-oxdyiethylene sulfonamide, zinc 2-ethyl hexanoate, and mercaptobenzothiazole disulfide.

7. The curative system of claim 1, wherein the metal oxide is present in an amount between about 0.5 and about 1.75 phr.

8. The curative system of claim 1, wherein metal oxide is present in an amount between about 0.3 and about 1.75 phr.

9. The curative system of claim 1, wherein the fatty acid is present in an amount between about 0.3 and about 0.5 phr.

10. The curative system of claim 1, wherein the sulfur is present in an amount between less than or equal to about 1 phr.

11. The curative system of claim 1, wherein the sulfur is present in an amount between less than or equal to about 0.5 phr.

12. The curative system of claim 1, wherein the cure accelerator is present in an amount less than or equal to about 1 phr.

13. A composition comprising:
(a) an isobutylene based polymer; and
(b) a curative system, comprising a reaction product of about 0.5 to about 3 phr metal oxide, about 0.3 to about 3 phr fatty acid, less than or equal to about 2 phr sulfur; and less than or equal to about 2 phr cure accelerator.

14. The composition of claim 13, wherein the isobutylene based polymer is isobutylene co-para-methyl styrene based elastomer.

15. The composition of claim 13, wherein the isobutylene based polymer is a homo-polymer, a copolymer, homo-polymer blend, or copolymer blend.

16. A method of making the composition of claim 13, comprising the steps of (a) curing the isobutylene based polymer with the curative system; and (b) recovering a butyl-based composition.

17. A composition comprising:
(a) a polymer;
(b) a secondary polymer, wherein the secondary polymer is the same or different from the polymer and is selected from the group consisting of natural rubber, cis-polyisoprene, styrene butadiene rubber, and ethylene propylene diene rubber;
(c) a resin; and
(d) a curative system comprising a reaction product of about 0.5 to about 3 phr metal oxide, about 0.3 to about 3 phr fatty acid, less than or equal to about 2 phr sulfur; and
less than or equal to about 2 phr cure accelerator.

18. The composition of claim 17, further comprising process oil.

19. The composition of claim 17, further comprising a filler.

20. The composition of claim 17, further comprising a plasticizer.

21. A method of making the composition of claim 17, comprising the steps of (a) mixing the polymer, the secondary polymer, and the homogenizing resin to produce a rubber mixture; (b) curing the rubber mixture with the curative system; and (c) recovering a butyl-based composition.

22. A tire component comprising the composition of claim 13.
